(19) United States
(12) Patent Application Publication
(10) Pub. No.: US 2026/0147739 A1
(43) Pub. Date: May 28, 2026

(54) METHODS AND SYSTEMS THAT AUTOMATICALLY GENERATE AND STORE DOCUMENTATION, ASSETS, AND ARTIFACTS THAT REPRESENT THE PROCESS AND PRODUCTS OF DATA-SCIENCE MODEL-GENERATION PIPELINES

(71) Applicant: Anaconda, Inc., Austin, TX (US)

(72) Inventors: Bryan Daversa, San Francisco, CA (US); Aidan Nell, H¿ Chí Minh (VN); Gregory Haardt, San Carlos, CA (US)

(21) Appl. No.: 19/380,313

(22) Filed: Nov. 5, 2025

Related U.S. Application Data
(60) Provisional application No. 63/724,225, filed on Nov. 22, 2024.

(51) Int. Cl. G06F 16/21

(52) U.S. Cl. CPC G06F 16/219

(57) ABSTRACT

The current document is directed to methods and systems that automate generation and storage of documentation and intermediate results produced during computational-model-generation processes. In described implementations, a listener process is established within development-environment components of a data-science pipeline. Each listener detects data-collection events and automatically stores information extracted from the development environment in which it is established. The automatically stored information is processed and aggregated, along with various intermediate products and results and/or references to the intermediate products and results, for forwarding to a backend process that analyzes and further processes the forwarded information for storage in a centralized database. The centralized database can be subsequently used to provide a detailed history of the steps carried out in a data-science pipeline and to reconstruct data-science-pipeline states at specified time points and to generate evidentiary records or reports suitable for compliance and audit purposes.

### CROSS-REFERENCE TO RELATED APPLICATION

This application claims the benefit of Provisional Application No. 63/724,225, filed Nov. 22, 2024, the contents of which is hereby expressly incorporated by reference in its entirety.

### TECHNICAL FIELD

The current document is directed to methods and systems that facilitate generation, organization, and storage of documentation, assets, and artifacts that represent the process and products of data-science model-generation pipelines.

### BACKGROUND

The development of modern electronics, including a wide variety of different types of integrated circuits, from microprocessors, personal computers, and other processor-controlled computing devices to large distributed computer systems, and advancements in computer science, including modern programming languages, development environments, database-management systems, and machine-learning-based and artificial-intelligence-based computational systems, have together provided a platform for development of sophisticated automated analysis, prediction, and inference systems based on computational models. The relatively new field of data science involves a variety of different disciplines for generating the computational models used in the automated analysis, prediction, and inference systems.

Data scientists employ methods and technologies that together comprise data-science pipelines. A data-science pipeline is a complex process of data-set selection and/or generation, model selection and/or generation, model training, and model validation that leads to the production of one or more computational models that can be used as components of automated-analysis systems, computational-modeling systems, and prediction-and-inference systems. Currently, many steps in the data-science pipelines are manual or semi-automated, requiring data scientists to make many decisions and carry out many manual steps, including generation of documentation that describes the model-generation process. The documentation written by the data scientists is used for subsequently understanding the process by which the computational models have been generated and for validating the generated computational models. In addition, the model-generation process often involves following many different paths that do not result in the production of suitable models, and data scientists often need to return to previous states of the data-science pipelines in order to select and follow alternative paths. To do so, data scientists rely on stored documentation, intermediate models, and other products of the data-science pipeline in order to resume the model-generation process from a previous state. However, because documentation and intermediate-results storage-and-organization steps are currently carried out manually or semi-automatically, data scientists often fail to generate and/or store the information needed for reconstructing previous states of the data-science pipeline, for post-model-generation validation and analysis, and for analysis of the model-generation process. Data scientists and system developers that depend on data scientists for generating computational models continue to seek improvements to data-science pipelines in order to systematically generate and store the information needed for reconstructing intermediate steps in the model-generation process, for fully understanding the steps taken to generate particular models, for subsequently analyzing and validating computational models, and for analyzing and improving the model-generation process.

### SUMMARY

The current document is directed to methods and systems that automate generation and storage of documentation and intermediate results produced during computational-model-generation processes. In described implementations, a listener process is established within development-environment components of a data-science pipeline. Each listener detects data-collection events and automatically stores information extracted from the development environment in which it is established. The automatically stored information is processed and aggregated, along with various intermediate products and results and/or references to the intermediate products and results, for forwarding to a backend process that analyzes and further processes the forwarded information for storage in a centralized database. The centralized database can be subsequently used to provide a detailed history of the steps carried out in a data-science pipeline, to reconstruct data-science-pipeline states at specified time points, and to generate evidentiary records or reports suitable for compliance and audit purposes.

### BRIEF DESCRIPTION OF THE DRAWINGS

FIG. 1 provides a general architectural diagram for various types of computers.

FIG. 2 illustrates an Internet-connected distributed computer system.

FIG. 3 illustrates cloud computing.

FIG. 4 illustrates generalized hardware and software components of a general-purpose computer system.

FIGS. 5A-B illustrate several types of virtual machine and virtual-machine execution environments.

FIG. 6 illustrates a data set.

FIG. 7 illustrates computational-model generation and the use of computational models.

FIGS. 8A-B illustrate two different types of models and associated model-generation processes.

FIGS. 9A-D illustrate polynomial data models.

FIG. 10 illustrates fundamental components of a feed-forward neural network.

FIGS. 11A-F illustrate a matrix-operation-based batch method for neural-network training.

FIG. 12 illustrates various types of validation parameters that can be calculated for a particular neural-network-based prediction model.

FIG. 13 illustrates five different classes of entities that are consumed and produced in a data-science pipeline, also referred to as a “model-generation process.”

FIG. 14 shows a simplified state-transition diagram for typical data-science pipelines.

FIG. 15 illustrates the documentation that is desirably produced in each of the data-science-pipeline steps shown in FIG. 14.

FIG. 16 illustrates a portion of a data-science-pipeline instance.

FIG. 17 illustrates a development environment used by a data scientist for carrying out tasks associated with a data-science pipeline.

FIG. 18 illustrates an entity-descriptor that represents a data-science-pipeline asset, transformation, or artifact.

FIG. 19 illustrates the various different types of edges in a graph generated from entity descriptors.

FIG. 20 shows a small example graph generated from entity descriptors that describe assets, transformations, and artifacts associated with a model-generation project.

FIG. 21 illustrates initiation and termination of data collection by a data scientist using the currently disclosed methods and systems.

FIG. 22 illustrates the parallel generation of data packages via multiple data scientists using multiple different development environments.

FIG. 23 illustrates update of the centralized database using information contained in a newly received autolog-information package.

FIGS. 24A-D provide control-flow diagrams that illustrate operation of the listener.

FIGS. 25A-C provide control-flow diagrams that illustrate operation of the backend.

### DETAILED DESCRIPTION

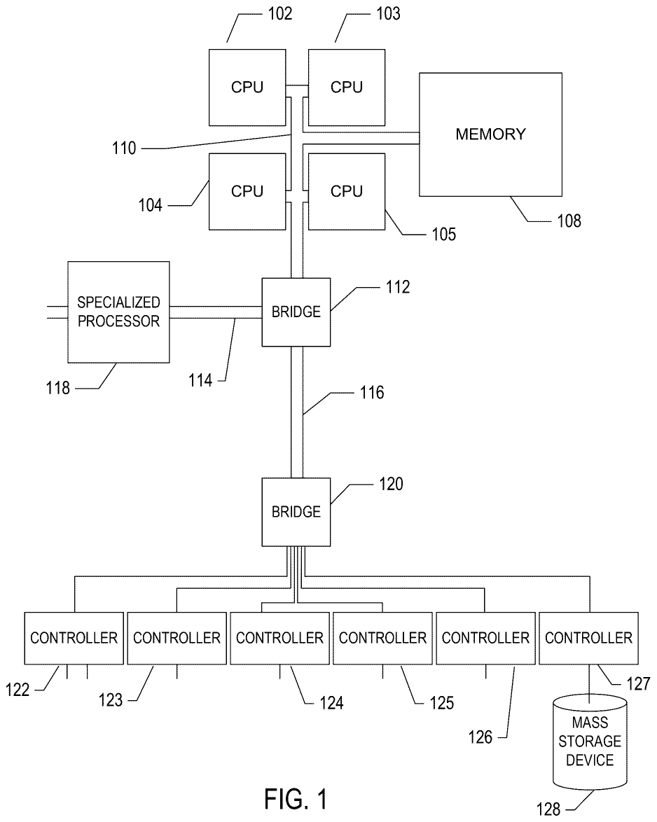

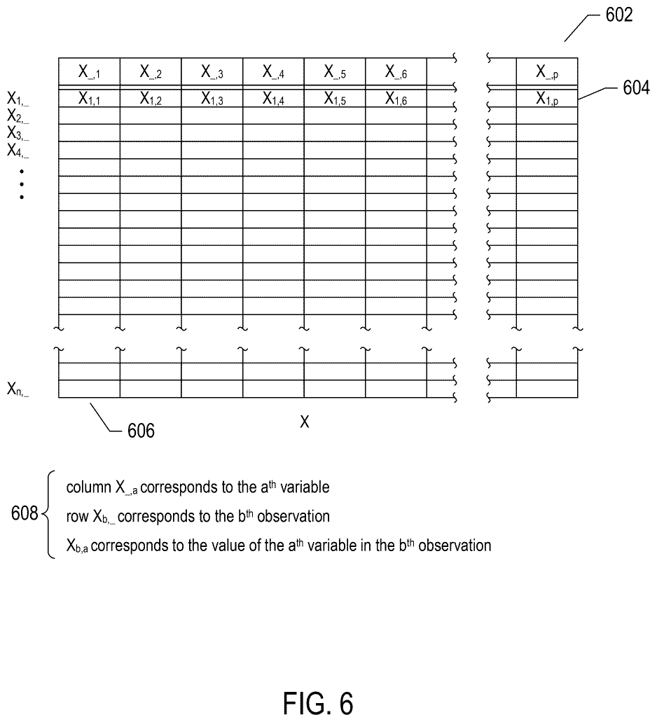

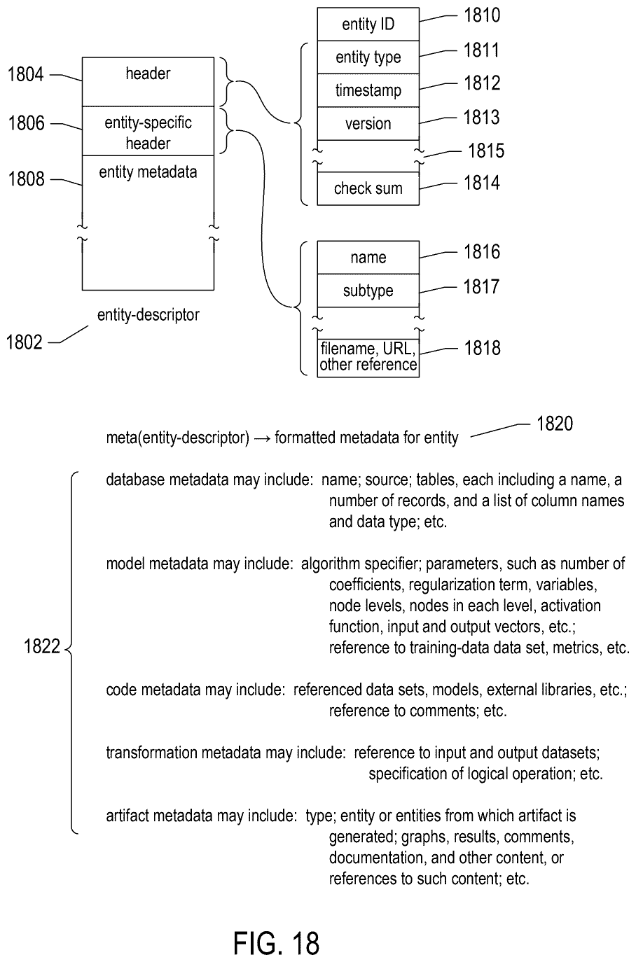

The current document is directed to methods and systems that automate generation and storage of documentation and the organization of intermediate results during computational-model generation by data scientists using data-science pipelines. In a first subsection, below, an overview of computer hardware, complex computational systems, and virtualization is provided with reference to FIGS. 1-5B. In a second subsection, an overview of data-science models and the model-generation process is provided with reference to FIGS. 6-17. Finally, in a third subsection, the currently disclosed methods and systems are discussed with reference to FIGS. 18-25C.

### Computer Hardware, Complex Computational Systems, and Virtualization

Computational abstractions are tangible, physical interfaces that are implemented, ultimately, using physical computer hardware, data-storage devices, and communications systems. In computing, the term “abstraction” refers to a logical level of functionality encapsulated within one or more concrete, tangible, physically implemented computer systems with defined interfaces through which electronically-encoded data is exchanged, process execution launched, and electronic services are provided. Interfaces may include graphical and textual data displayed on physical display devices as well as computer programs and routines that control physical computer processors to carry out various tasks and operations and that are invoked through electronically implemented application programming interfaces (“APIs”) and other electronically implemented interfaces. There is a tendency among those unfamiliar with modern technology and science to misinterpret the terms “abstract” and “abstraction,” when used to describe certain aspects of modern computing. For example, one frequently encounters assertions that, because a computational system is described in terms of abstractions, functional layers, and interfaces, the computational system is somehow different from a physical machine or device. Such assertions are unfounded. One only needs to disconnect a computer system or group of computer systems from their respective power supplies to appreciate the physical, machine nature of complex computer technologies. One also frequently encounters statements that characterize a computational technology as being “only software,” and thus not a machine or device. Software is essentially a sequence of encoded symbols, such as a printout of a computer program or digitally encoded computer instructions sequentially stored in a file on an optical disk or within an electromechanical mass-storage device. Software alone can do nothing. It is only when encoded computer instructions are loaded into an electronic memory within a computer system and executed on a physical processor that so-called “software implemented” functionality is provided. The digitally encoded computer instructions are an essential and physical control component of processor-controlled machines and devices, no less essential and physical than a cam-shaft control system in an internal-combustion engine. Multi-cloud aggregations, cloud-computing services, virtual-machine containers and virtual machines, communications interfaces, and many of the other topics discussed below are physical, electromechanical systems or components of physical, electromechanical systems.

FIG. 1 provides a general architectural diagram for various types of computers. The computer system contains one or multiple central processing units (“CPUs”) 102-105, one or more electronic memories 108 interconnected with the CPUs by a CPU/memory-subsystem bus 110 or multiple buses, a first bridge 112 that interconnects the CPU/memory-subsystem bus 110 with additional buses 114 and 116, or other types of high-speed interconnection media, including multiple, high-speed serial interconnects. These buses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational resources. It should be noted that computer-readable data-storage devices include optical and electromagnetic disks, electronic memories, and other physical data-storage devices. Those familiar with modern science and technology appreciate that electromagnetic radiation and propagating signals do not store data for subsequent retrieval and can transiently “store” only a byte or less of information per mile, far less information than needed to encode even the simplest of routines. The various types of computers, including personal computers, laptops, smartphones, workstations, tablets, and other such devices used by individuals may be referred to as “processor-controlled devices” or “processor-controlled appliances.”

Of course, there are many different types of computer-system architectures that differ from one another in the number of different memories, including different types of hierarchical cache memories, the number of processors and the connectivity of the processors with other system components, the number of internal communications buses and serial links, and in many other ways. However, computer systems generally execute stored programs by fetching instructions from memory and executing the instructions in one or more processors. Computer systems include general-purpose computer systems, such as personal computers (“PCs”), various types of servers and workstations, and higher-end mainframe computers, but may also include a plethora of various types of special-purpose computing devices, including data-storage systems, communications routers, network nodes, tablet computers, and mobile telephones.

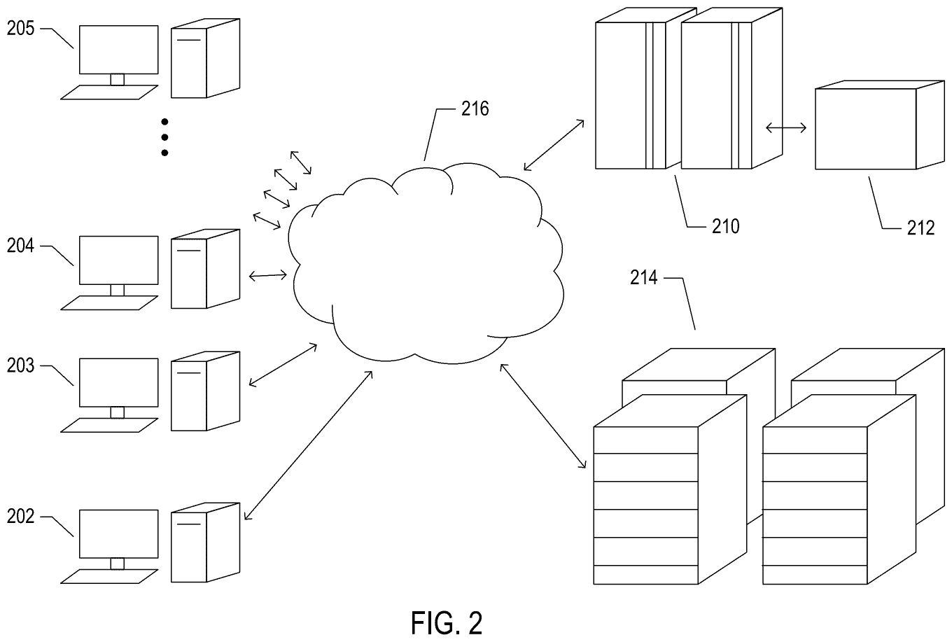

FIG. 2 illustrates an Internet-connected distributed computer system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted servers or blade servers all interconnected through various communications and networking systems that together comprise the Internet 216. Such distributed computer systems provide diverse arrays of functionalities. For example, a PC user sitting in a home office may access millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web servers, back-end computer systems, and data-storage systems for serving web pages to remote customers, receiving orders through the web-page interface, processing the orders, tracking completed orders, and other myriad different tasks associated with an e-commerce enterprise.

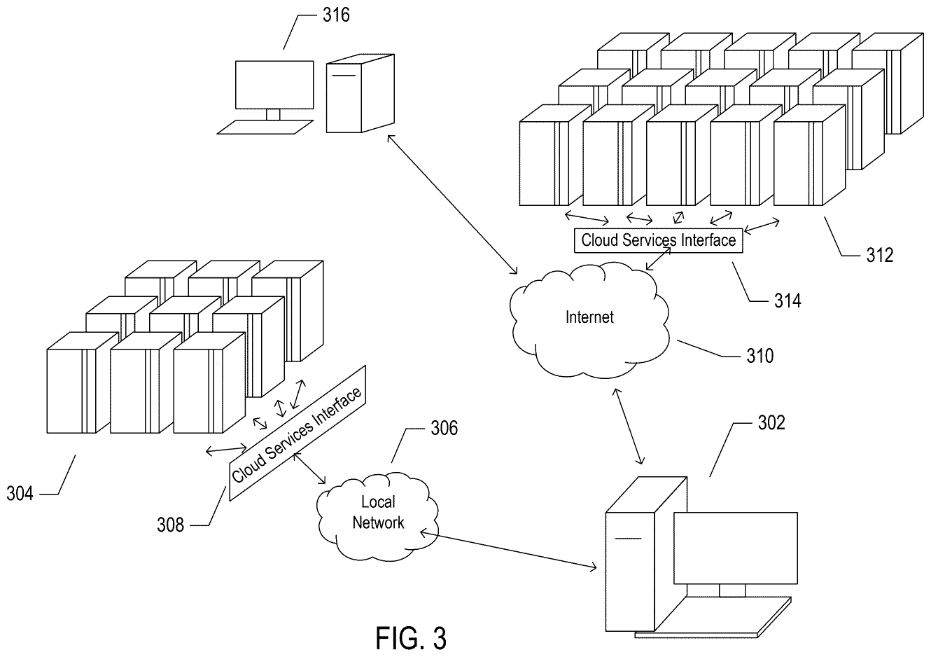

FIG. 3 illustrates cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and also accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the resources to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

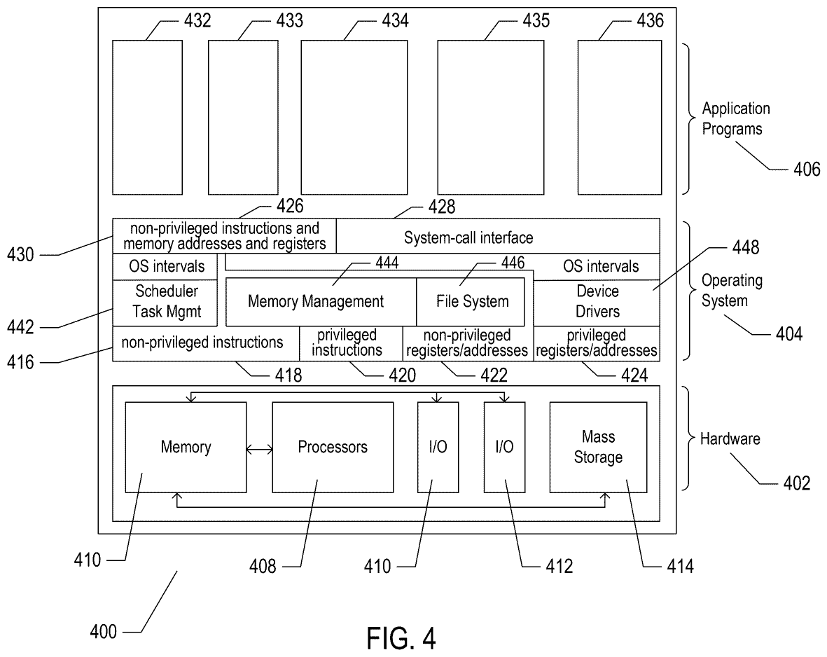

FIG. 4 illustrates generalized hardware and software components of a general-purpose computer system. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, various different types of input-output (“I/O”) devices 410 and 412, and mass-storage devices 414. Of course, the hardware level also includes many other components, including power supplies, internal communications links and buses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor resources and other system resources with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 436 facilitates abstraction of mass-storage-device and memory resources as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems and can therefore be executed within only a subset of the various different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computer system for high-availability, fault-tolerance, and load-balancing purposes. The problems are even greater in heterogeneous distributed computer systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

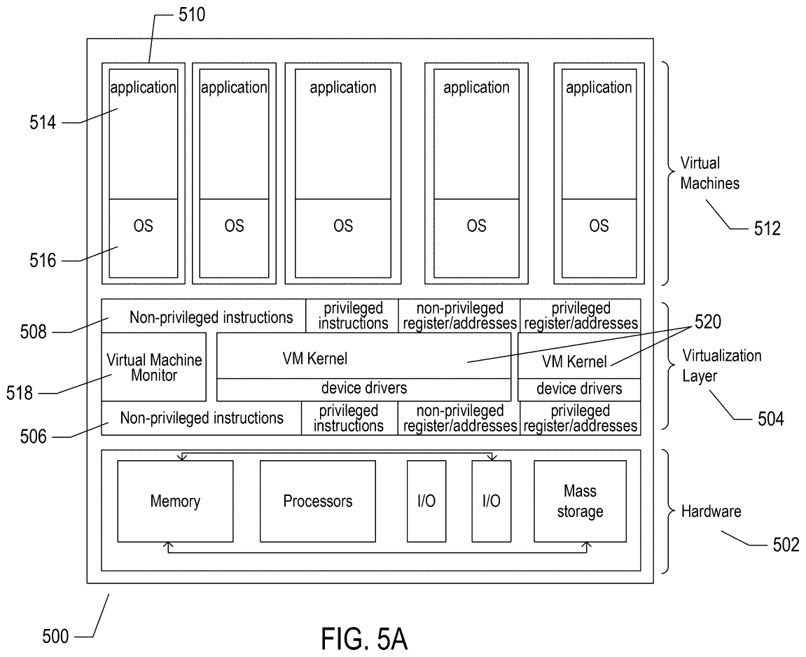

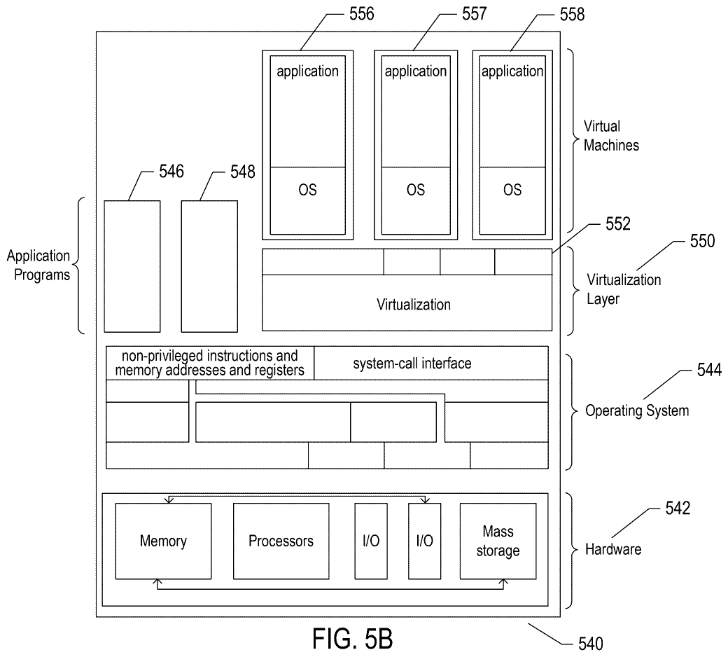

For all of these reasons, a higher level of abstraction, referred to as the “virtual machine,” has been developed and evolved to further abstract computer hardware in order to address many difficulties and challenges associated with traditional computing systems, including the compatibility issues discussed above. FIGS. 5A-B illustrate several types of virtual machine and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment illustrated in FIG. 5A features a virtualization layer 504 that interfaces through a virtualization-layer/hardware-layer interface 506, equivalent to interface 416 in FIG. 4, to the hardware. The virtualization layer provides a hardware-like interface 508 to a number of virtual machines, such as virtual machine 510, executing above the virtualization layer in a virtual-machine layer 512. Each virtual machine includes one or more application programs or other higher-level computational entities packaged together with an operating system, referred to as a “guest operating system,” such as application 514 and guest operating system 516 packaged together within virtual machine 510. Each virtual machine is thus equivalent to the operating-system layer 404 and application-program layer 406 in the general-purpose computer system shown in FIG. 4. Each guest operating system within a virtual machine interfaces to the virtualization-layer interface 508 rather than to the actual hardware interface 506. The virtualization layer partitions hardware resources into abstract virtual-hardware layers to which each guest operating system within a virtual machine interfaces. The guest operating systems within the virtual machines, in general, are unaware of the virtualization layer and operate as if they were directly accessing a true hardware interface. The virtualization layer ensures that each of the virtual machines currently executing within the virtual environment receive a fair allocation of underlying hardware resources and that all virtual machines receive sufficient resources to progress in execution. The virtualization-layer interface 508 may differ for different guest operating systems. For example, the virtualization layer is generally able to provide virtual hardware interfaces for a variety of different types of computer hardware. This allows, as one example, a virtual machine that includes a guest operating system designed for a particular computer architecture to run on hardware of a different architecture. The number of virtual machines need not be equal to the number of physical processors or even a multiple of the number of processors.

The virtualization layer includes a virtual-machine-monitor module 518 (“VMM”) that virtualizes physical processors in the hardware layer to create virtual processors on which each of the virtual machines executes. For execution efficiency, the virtualization layer attempts to allow virtual machines to directly execute non-privileged instructions and to directly access non-privileged registers and memory. However, when the guest operating system within a virtual machine accesses virtual privileged instructions, virtual privileged registers, and virtual privileged memory through the virtualization-layer interface 508, the accesses result in execution of virtualization-layer code to simulate or emulate the privileged resources. The virtualization layer additionally includes a kernel module 520 that manages memory, communications, and data-storage machine resources on behalf of executing virtual machines (“VM kernel”). The VM kernel, for example, maintains shadow page tables on each virtual machine so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer essentially schedules execution of virtual machines much like an operating system schedules execution of application programs, so that the virtual machines each execute within a complete and fully functional virtual hardware layer.

FIG. 5B illustrates a second type of virtualization. In FIG. 5B, the computer system 540 includes the same hardware layer 542 and software layer 544 as the hardware layer 402 shown in FIG. 4. Several application programs 546 and 548 are shown running in the execution environment provided by the operating system. In addition, a virtualization layer 550 is also provided, in computer 540, but, unlike the virtualization layer 504 discussed with reference to FIG. 5A, virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 508 in FIG. 5A. The virtualization-layer/hardware-layer interface 552, equivalent to interface 416 in FIG. 4, provides an execution environment for a number of virtual machines 556-558, each including one or more application programs or other higher-level computational entities packaged together with a guest operating system.

### Overview of Data-Science Models and the Model-Generation Process

FIG. 6 illustrates a data set. Data sets are primary and fundamental inputs to the computation-model generation process. A data set X is often viewed as a table 602 containing rows, such as the first row 604 in table 602, and columns, such as the first column 606 in table 602. The data set X is thus visualized as a two-dimensional matrix. As indicated in the text 608 below table 602 in FIG. 6, indices are often used to indicate components of the table or data set. The first index indicates a particular row and a second index indicates a particular column. For example, a particular row, or observation, b is indicated as X_{b} and a particular column, or variable, a is represented as X_{,a}. When two indices are used, such as X_{b,a}, a particular value of the variable a in observation b is indicated. Variables are generally measurable or determinable values that together comprise an observation. For example, in a data set in which the observations represent human members of a particular group, such as the patrons of a retail establishment at particular dates and times, the variables may include a patron's name, age, gender, and address. The variables may also include a date and time indicating when the patron was observed in the retail establishment. Alternatively, each data set may be associated with a particular date and time interval, in which case date and time variables need not be included in each data set. Data sets are often extracted from the information contained in databases, text files, webpages, and other information sources and may be formatted and stored in memory in many different ways. However, logically, they are often viewed as two-dimensional tables, as discussed above with reference to table 602 representing the data set X.

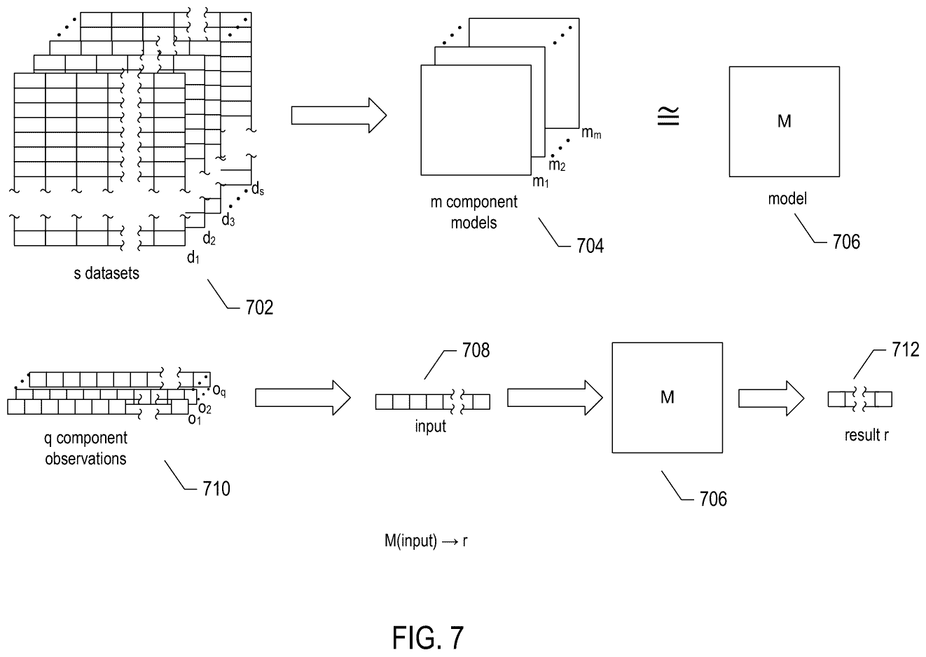

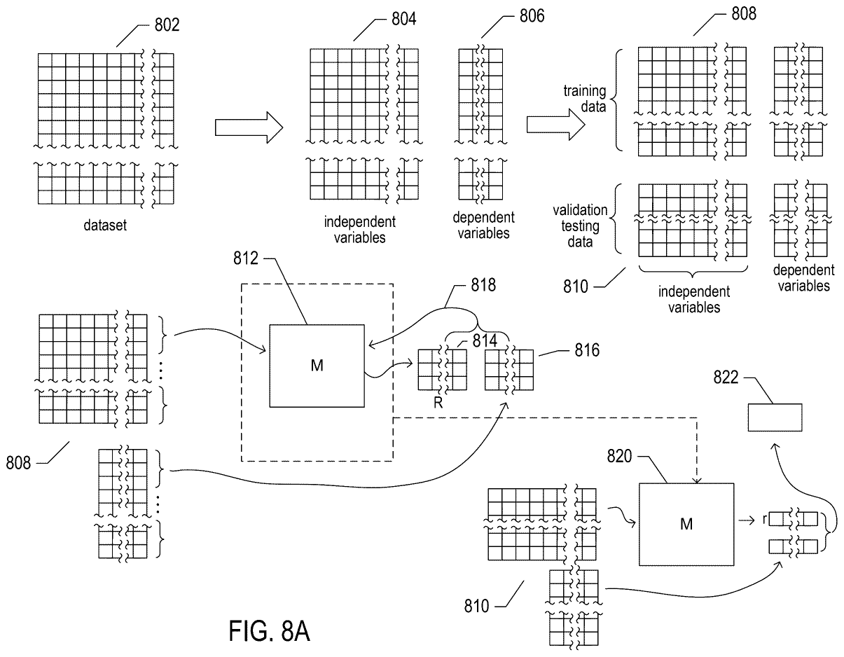

FIG. 7 illustrates computational-model generation and the use of computational models. As mentioned above, data sets 702 represent a primary and fundamental input to the computational-model-generation process. In general, multiple data sets 702 are used to generate multiple component computational models 704 that together comprise a logical computational model 706 that represents the results of a data-science pipeline or computational-model-generation process. Subsequently, the logical model can be used for a variety of different purposes, including prediction, inference, classification, and other uses. In general, an input 708 to the model 706 is generated from one or more observations 710. The logical model 706 outputs a result 712 in response to receiving the input 708. For example, the logical model may receive input values that represent characteristics of a real estate property, such as the size of a house, in square feet, the number of bedrooms and bathrooms in the house, the location of the house, the size of the lot, the age of the house, and other such characteristics and may return an estimated maximum listing price for the property that would result in a sale within three months. As another example, the logical model may receive input values that represent characteristics of an individual seeking a loan from a bank and the logical model might return one of a small number of different classification values indicating the likelihood that the individual will default on one or more loan repayments. The current document is concerned with the process by which computational models are generated, as represented by the top portion of FIG. 7. The computational models can be used in a variety of ways in numerous different types of applications and systems, as represented by the lower portion of FIG. 7.

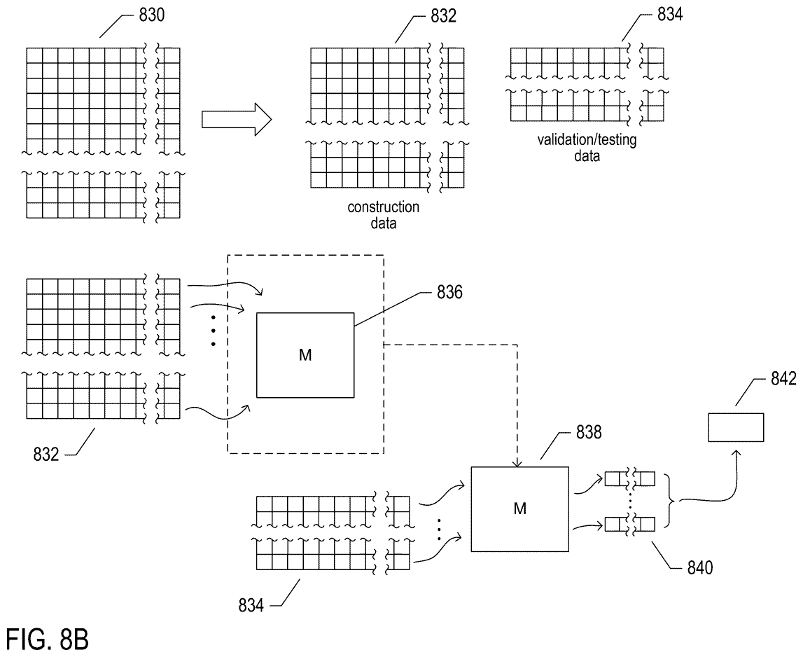

FIGS. 8A-B illustrate two different types of models and associated model-generation processes. FIG. 8A illustrates models that are generated using supervised-learning approaches. A data set 802, which may be generated from one or more input data sets, is partitioned into a generally larger set of independent variables 804 and a generally smaller set of dependent variables 806. The set of independent variables and the set of dependent variables are then partitioned into training data 808 and validation/testing data 810. Both the training data and the validation/testing data include independent-variable portions and dependent-variable portions. An initial untrained model 812 is selected based on the desired results and the characteristics of the independent and dependent variables. The model is then trained using the training data 808 in a supervised-learning process which involves computing differences between results generated by the model 814 and the corresponding dependent variables 816 and then feeding the differences back into the model, as represented by arrow 818, to adjust the model in order to produce an adjusted model that produces outputs from subsequently input independent-variable data that more closely match the dependent-variable data corresponding to the subsequently input independent-variable data. In general, small batches of independent-variable training data are input to the model to produce small batches of results which are then compared to corresponding small batches of dependent-variable training data to produce the differences that are fed back into the model. Once the training is complete, the trained model 820 is then validated using the validation/testing data 810, with the differences between the outputs of the trained model and the corresponding dependent-variable validation/testing data used to compute validation parameters and statistics 822. Examples of models generated by supervised-learning approaches include neural networks and large-language models. The training data and validation may not be extracted from a single data set, but may instead be obtained from different sources at different times. Training may be periodic, so that the model is adjusted periodically or intermittently after initial training. Trained models may also be subsequently altered to optimize performance and efficiency.

FIG. 8B illustrates models that are not generated using supervised-learning approaches. In this case, the data set 830 is partitioned into construction data 832 and validation/testing data 834. The model 836 is obtained using the construction data 832. Once constructed, the finished model 838 is validated using the validation/testing data 834 to produce results 840 from which validation parameters and statistics 842 are generated. An example of a model that is not generated using supervised-learning approaches is a clustering model that assigns input data derived from observations to one of multiple different clusters, or categories, that are discovered during the construction process.

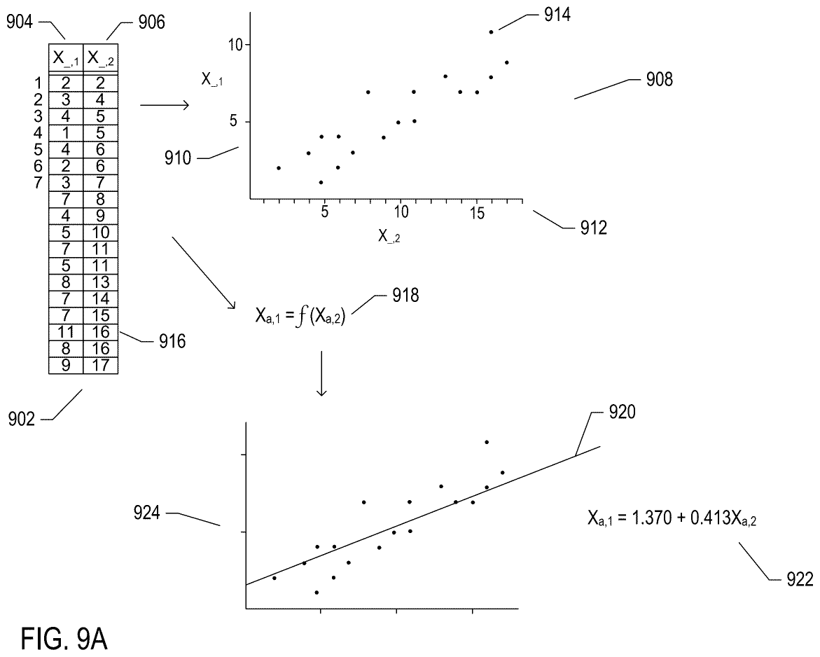

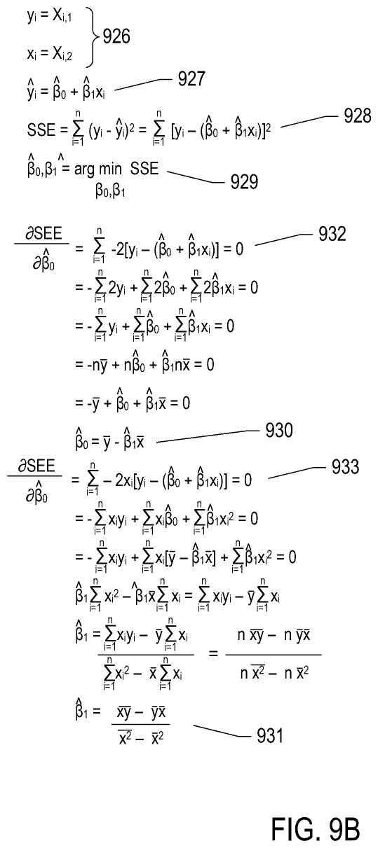

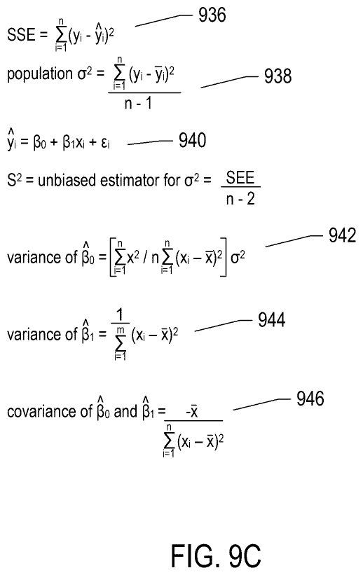

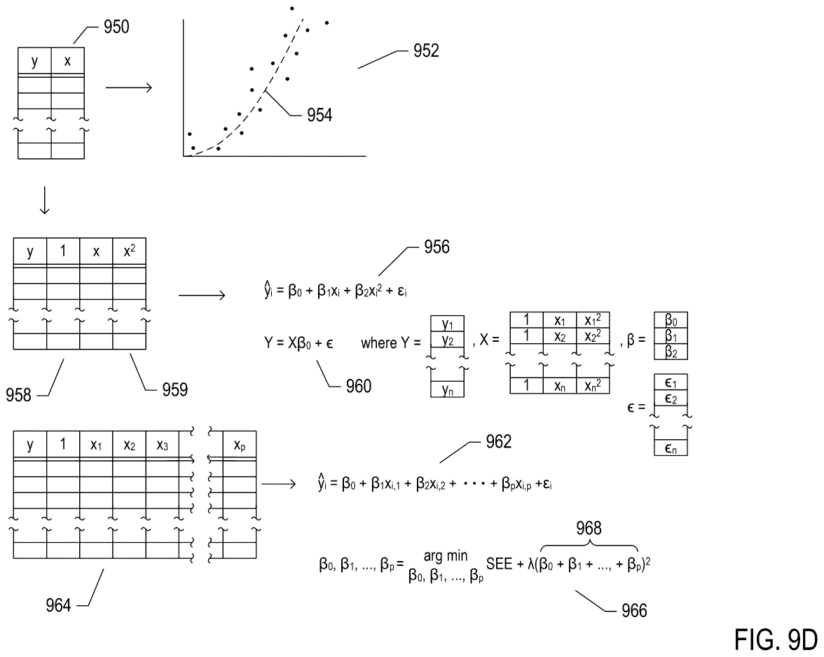

FIGS. 9A-D illustrate polynomial data models. FIG. 9A illustrates a simple linear model, possibly the simplest computational model. The input data set 902 includes a first dependent variable 904 and a second independent variable 906. Plot 908 shows a plot of the observations, or data points, that together comprise data set 902. As is the normal convention, the dependent-variable values are plotted with respect to a vertical axis 910 and the independent-variable values are plotted with respect to a horizontal axis 912. Each plotted data point, such as data point 914, corresponds to an observation, in the case of data point 914, observation 916. The computational model for data set 902 will be a function 1918 that maps the values of the independent variable to the values of the corresponding dependent variable. A review of plot 908 indicates that the data points may be distributed roughly linearly. Thus, a simple linear model is chosen: X_{a,1}=β₀+β₀X_{a,2} for a given observation a. Using data set 902, in a process described below, the coefficients β₀ and β₁ are determined to be 1.370 and 0.413, respectively, and a line 920 representing the computational model is plotted in addition to the data points in plot 924. Model 922, a simple polynomial, can be used to predict the dependent variable of a data point given an independent-variable value.

FIG. 9B shows a method that determines the coefficients β₀ and β₁ for model 922 shown in FIG. 9A. First, as shown in expressions 926, yᵢ and xᵢ are used to denote the dependent and independent variables for an arbitrary observation i, as is the standard convention. Expression 927 represents the simple linear polynomial model. Note that the hat symbols indicate predictive values. Expression 928 indicates how the sum of the squared errors (“SSE”) is computed. Expression 929 indicates that the predicted coefficient values are obtained as a minimization problem in which the predicted values of the coefficients are those that minimize the SSE. In the case of a simple linear polynomial, analytical expressions for the two coefficients, 930 and 931, respectively, are obtained by solving for coefficient values that render the partial derivatives of the SSE with respect to each coefficient zero, shown in expressions 932 and 933, respectively.

FIG. 9C shows a number of simple statistics, calculated using the data set and the model. that can be used for validation purposes. These statistics include the SSE 936 and the population variance 938. In addition, when an error term is added to the model, as shown in expression 940, the variances of the predicted coefficients can be computed by expressions 942 and 944 and the covariance of the two coefficients can be computed using expression 946. In general, the lower the variance, the better the model.

FIG. 9D illustrates several additional polynomial models. When the data points from a data set 950, similar to data set 902 in FIG. 9A, are plotted in plot 952, it appears, by inspection, that the underlying model might best be represented by a nonlinear polynomial, as indicated by dotted curve 954. In this case, a model quadratic in the independent variable 956 is chosen. In order to support this model, two additional columns 958 and 959 are added to the data set. The values in column 958 are all 1 and the values in column 959 are derived from the values of independent-variable values in data set 950, namely the squares of those values. Column 959 is an example of an additional feature added to a data set. The model can be reformulated in matrix notation as expression 960 and values for the coefficients can be found by a minimization method. Note that, in the minimization method, the unknown coefficients for the model are the variables rather than the data set variables and features. A variety of different polynomial models, such as model 962, may be selected for various different types of data sets, such as data set 964. Model 962 is linear in the data-set variables, but, like model 956, additional models can be selected that are nonlinear in one or more of the variables. In addition, certain additional types of models, such as model 966, may include additional terms in the quantity minimized to determine coefficient values, such as additional term 968, which is a regularization term used to constrain the magnitudes of the predicted coefficient values.

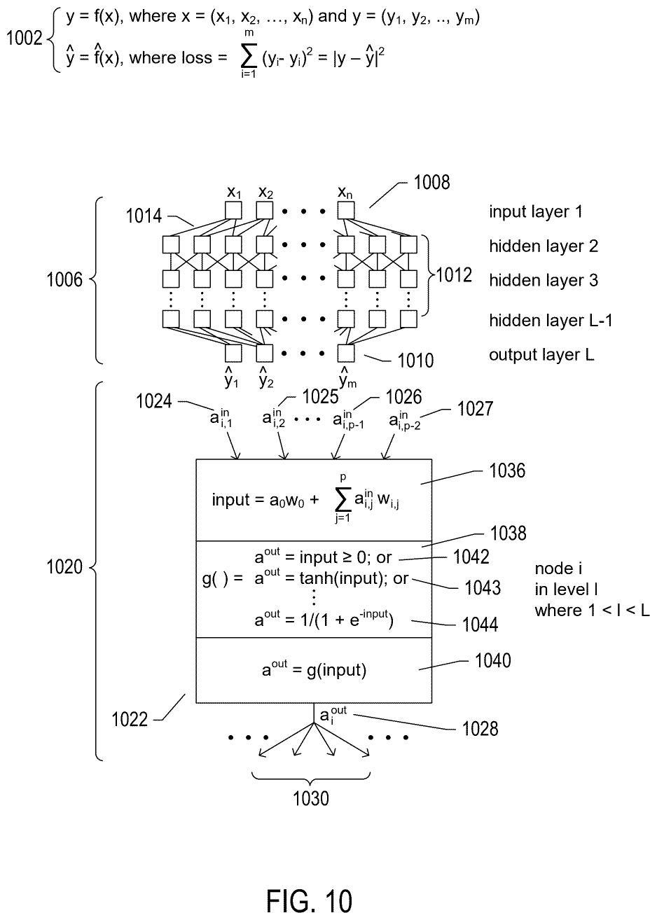

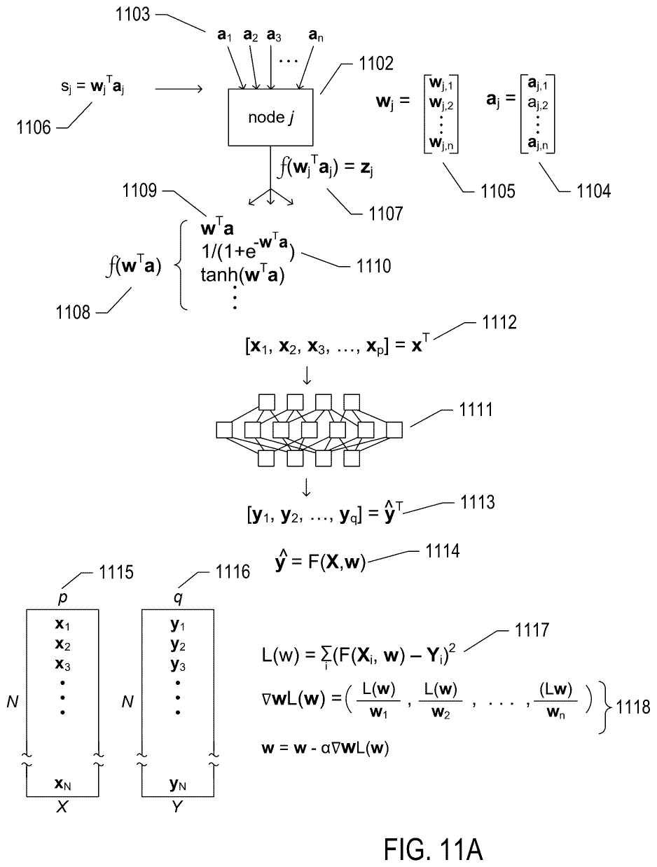

As mentioned above, neural networks or another type of model. Neural networks are essentially high dimensional, non-linear functions that map input vectors to output vectors. They can be used for many different types of purposes, including prediction, inference, classification, and other such purposes. FIG. 10 illustrates fundamental components of a feed-forward neural network. Expressions 1002 mathematically represent ideal operation of a neural network as a function ƒ(x). The function receives an input vector x and outputs a corresponding output vector y 1103. For example, an input vector may be a digital image represented by a two-dimensional array of pixel values in an electronic document or may be an ordered set of numeric or alphanumeric values. Similarly, the output vector may be, for example, an altered digital image, an ordered set of one or more numeric or alphanumeric values, an electronic document, or one or more numeric values. The initial expression of expressions 1002 represents the ideal operation of the neural network. In other words, the output vector y represents the ideal, or desired, output for corresponding input vector x. However, in actual operation, a physically implemented neural network \hat{ƒ}(x), as represented by the second expression of expressions 1002, returns a physically generated output vector ŷ that may differ from the ideal or desired output vector y. An output vector produced by the physically implemented neural network is associated with an error or loss value. A common error or loss value is the square of the distance between the two points represented by the ideal output vector y and the output vector produced by the neural network ŷ. The distance between the two points represented by the ideal output vector and the output vector produced by the neural network, with optional scaling, may also be used as the error or loss. A neural network is trained using a training dataset comprising input-vector/ideal-output-vector pairs, generally obtained by human or human-assisted assignment of ideal-output vectors to selected input vectors. The ideal-output vectors in the training dataset are often referred to as “labels.” During training, the error associated with each output vector, produced by the neural network in response to input to the neural network of a training-dataset input vector, is used to adjust internal weights within the neural network in order to minimize the error or loss. Thus, the accuracy and reliability of a trained neural network is highly dependent on the accuracy and completeness of the training dataset.

As shown in the middle portion 1006 of FIG. 10, a feed-forward neural network generally consists of layers of nodes, including an input layer 1008, an output layer 1010, and one or more hidden layers 1012. These layers can be numerically labeled 1, 2, 3, . . . , L−1, L, as shown in FIG. 10. In general, the input layer contains a node for each element of the input vector and the output layer contains one node for each element of the output vector. The input layer and/or output layer may each have one or more nodes. In the following discussion, the nodes of a first level with a numeric label lower in value than that of a second layer are referred to as being higher-level nodes with respect to the nodes of the second layer. The input-layer nodes are thus the highest-level nodes. The nodes are interconnected to form a graph, as indicated by line segments, such as line segment 1014.

The lower portion of FIG. 10 (1020 in FIG. 10) illustrates a feed-forward neural-network node. The neural-network node 1022 receives inputs 1024-1027 from one or more next-higher-level nodes and generates an output 1028 that is distributed to one or more next-lower-level nodes 1030. The inputs and outputs are referred to as “activations,” represented by superscripted-and-subscripted symbols “a” in FIG. 10, such as the activation symbol 1024. An input component 1036 within a node collects the input activations and generates a weighted sum of these input activations to which a weighted internal activation a₀ is added. An activation component 1038 within the node is represented by a function g(), referred to as an “activation function,” that is used in an output component 1040 of the node to generate the output activation of the node based on the input collected by the input component 1036. The neural-network node 1022 represents a generic hidden-layer node. Input-layer nodes lack the input component 1036 and each receive a single input value representing an element of an input vector. Output-component nodes output a single value representing an element of the output vector. The values of the weights used to generate the cumulative input by the input component 1036 are determined by training, as previously mentioned. In general, the input, outputs, and activation function are predetermined and constant, although, in certain types of neural networks, these may also be at least partly adjustable parameters. In FIG. 10, three different possible activation functions are indicated by expressions 1042-1044. The first expression is a binary activation function and the third expression represents a sigmoidal relationship between input and output that is commonly used in neural networks and other types of machine-learning systems, both functions producing an activation in the range [0, 1]. The second function is also sigmoidal, but produces an activation in the range [−1, 1].

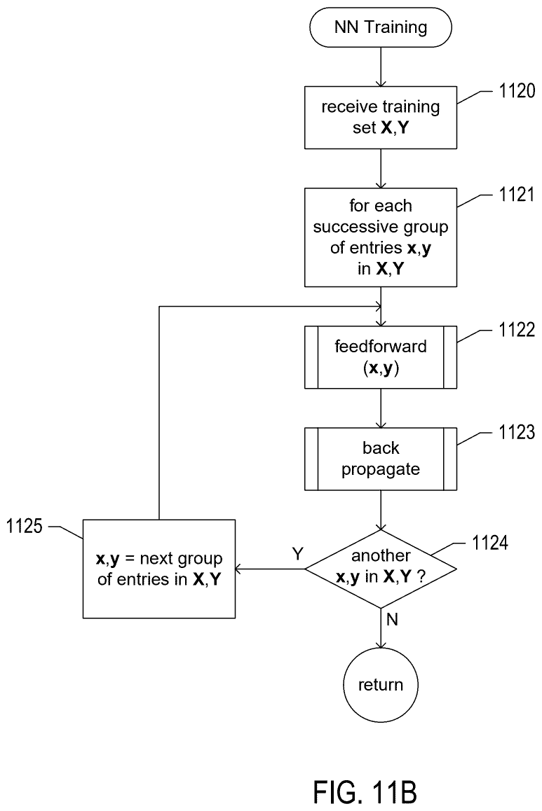

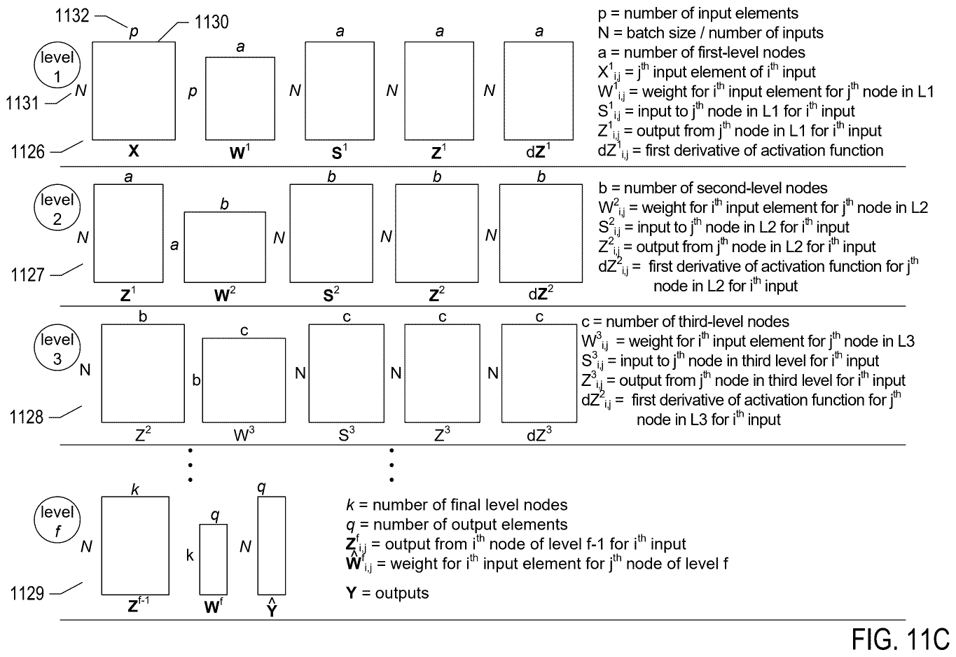

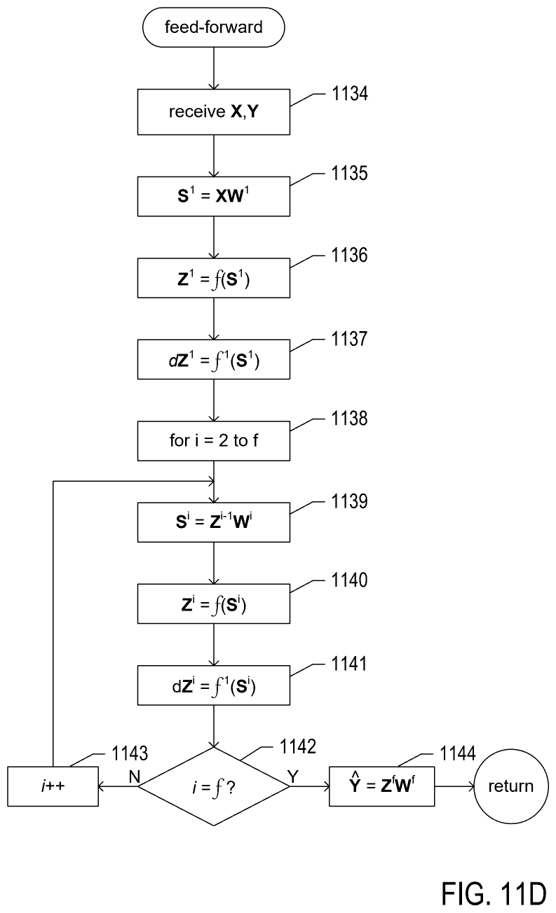

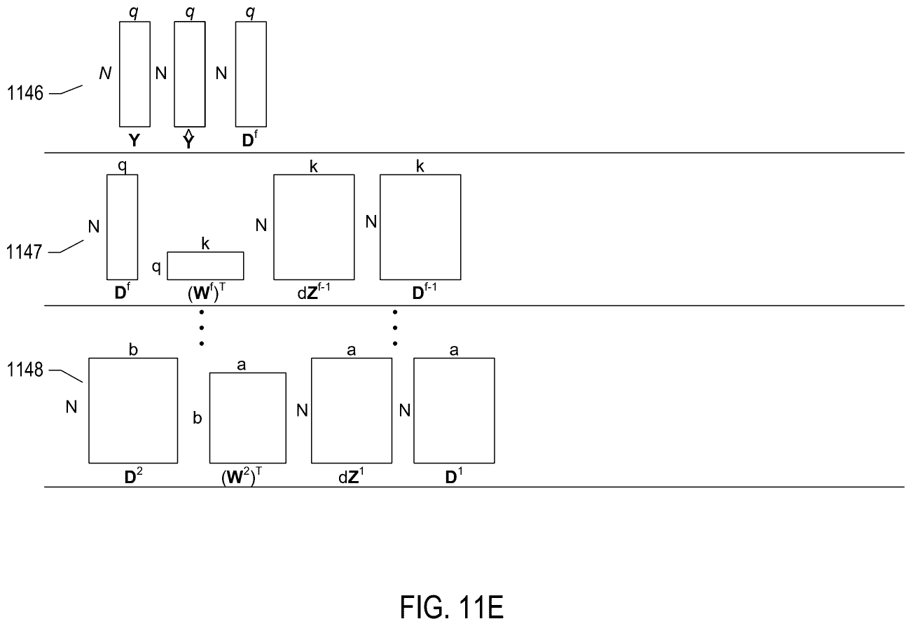

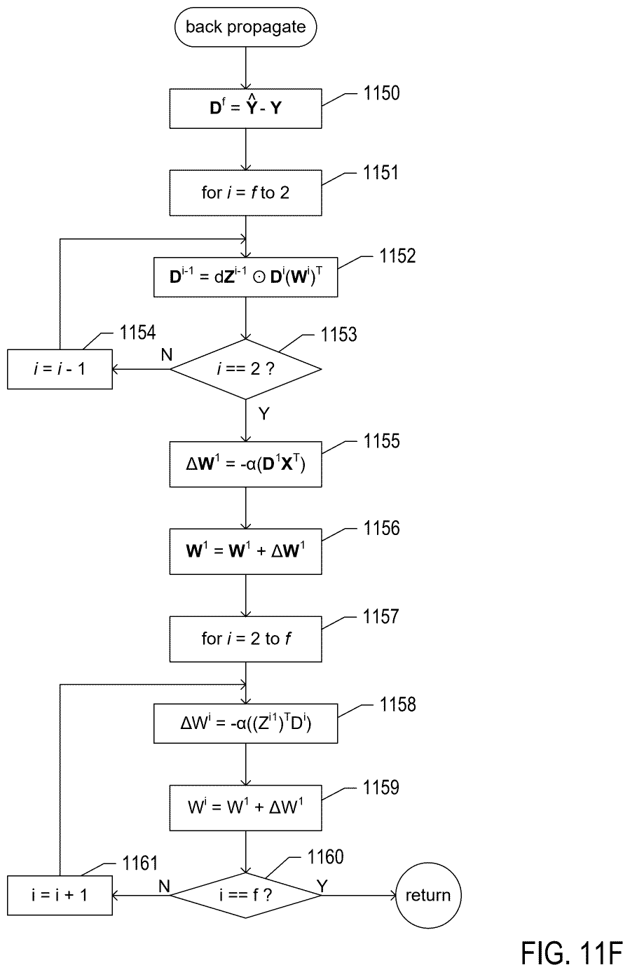

FIGS. 11A-F illustrate a matrix-operation-based batch method for neural-network training. This method processes batches of training data and losses to efficiently train a neural network. FIG. 11A illustrates the neural network and associated terminology. As discussed above, each node in the neural network, such as node j 1102, receives one or more inputs a 1103, expressed as a vector aⱼ 1104, that are multiplied by corresponding weights, expressed as a vector wⱼ 1105, and added together to produce an input signal sⱼ using a vector dot-product operation 1106. An activation function ƒ within the node receives the input signal sⱼ and generates an output signal zⱼ 1107 that is output to all child nodes of node j. Expression 1108 provides an example of various types of activation functions that may be used in the neural network. These include a linear activation function 1109 and a sigmoidal activation function 1110. As discussed above, the neural network 1111 receives a vector of p input values 1112 and outputs a vector of q output values 1113. In other words, the neural network can be thought of as a function F 1114 that receives a vector of input values x^{T} and uses a current set of weights w within the nodes of the neural network to produce a vector of output values ŷ^{T}. The neural network is trained using a training data set comprising a matrix X 1115 of input values, each of N rows in the matrix corresponding to an input vector x^{T}, and a matrix Y 1116 of desired output values, or labels, each of N rows in the matrix corresponding to a desired output-value vector y^{T}. A least-squares loss function is used in training 1117 with the weights updated using a gradient vector generated from the loss function, as indicated in expressions 1118, where α is a constant that corresponds to a learning rate.

FIG. 11B provides a control-flow diagram illustrating the method of neural-network training. In step 1120, the routine “NNTraining” receives the training set comprising matrices X and Y. Then, in the for-loop of steps 1121-1125, the routine “NNTraining” processes successive groups or batches of entries x and y selected from the training set. In step 1122, the routine “NNTraining” calls a routine “feedforward” to process the current batch of entries to generate outputs and, in step 1123, calls a routine “back propagated” to propagate errors back through the neural network in order to adjust the weights associated with each node.

FIG. 11C illustrates various matrices used in the routine “feedforward.” FIG. 11C is divided horizontally into four regions 1126-1129. Region 1126 approximately corresponds to the input level, regions 1127-1128 approximately correspond to hidden-node levels, and region 1129 approximately corresponds to the final output level. The various matrices are represented, in FIG. 11C, as rectangles, such as rectangle 1130 representing the input matrix X. The row and column dimensions of each matrix are indicated, such as the row dimension N 1131 and the column dimension p 1132 for input matrix X 1130. In the right-hand portion of each region in FIG. 11C, descriptions of the matrix-dimension values and matrix elements are provided. In short, the matrices W^{x} represent the weights associated with the nodes at level x, the matrices S^{x} represent the input signals associated with the nodes at level x, the matrices Z^{x} represent the outputs from the nodes at level x, and the matrices dZ^{x} represent the first derivative of the activation function for the nodes at level x evaluated for the input signals.

FIG. 11D provides a control-flow diagram for the routine “feedforward,” called in step 1122 of FIG. 11B. In step 1134, the routine “feedforward” receives a set of training data x and y selected from the training-data matrices X and Y. In step 1135, the routine “feedforward” computes the input signals S¹ for the first layer of nodes by matrix multiplication of matrices x and W¹, where matrix W¹ contains the weights associated with the first-layer nodes. In step 1136, the routine “feedforward” computes the output signals Z¹ for the first-layer nodes by applying a vector-based activation function ƒ to the input signals S¹. In step 1137, the routine “feedforward” computes the values of the derivatives of the activation function ƒ′, dZ¹. Then, in the for-loop of steps 1138-1143, the routine “feedforward” computes the input signals Sⁱ, the output signals Zⁱ, and the derivatives of the activation function dZⁱ for the nodes of the remaining levels of the neural network. Following completion of the for-loop of steps 1138-1143, the routine “feedforward” computes the output values ŷ^{T} for the received set of training data.

FIG. 11E illustrates various matrices used in the routine “back propagate.” FIG. 11E uses similar illustration conventions as used in FIG. 11C, and is also divided horizontally into horizontal regions 1146-1148. Region 1146 approximately corresponds to the output level, region 1147 approximately corresponds to hidden-node levels, and region 1148 approximately corresponds to the first node level. The only new type of matrix shown in FIG. 11E are the matrices D^{x} for node levels x. These matrices contain the error signals that are used to adjust the weights of the nodes.

FIG. 11F provides a control-flow diagram for the routine “back propagate.” In step 1150, the routine “back propagate” computes the first error-signal matrix D^{f} as the difference between the values ŷ output during a previous execution of the routine “feedforward” and the desired output values from the training set y. Then, in a for-loop of steps 1151-1154, the routine “back propagate” computes the remaining error-signal matrices for each of the node levels up to the first node level as the Shur product of the dZ matrix and the product of the transpose of the W matrix and the error-signal matrix for the next lower node level. In step 1155, the routine “back propagate” computes weight adjustments ΔW for the first-level nodes as the negative of the constant α times the product of the transpose of the input-value matrix and the error-signal matrix. In step 1156, the first-node-level weights are adjusted by adding the current W matrix and the weight-adjustments matrix ΔW. Then, in the for-loop of steps 1157-1161, the weights of the remaining node levels are similarly adjusted.

Thus, as shown in FIGS. 11A-F, neural-network training can be conducted as a series of simple matrix operations, including matrix multiplications, matrix transpose operations, matrix addition, and the Shur product. Interestingly, there are no matrix inversions or other complex matrix operations needed for neural-network training.

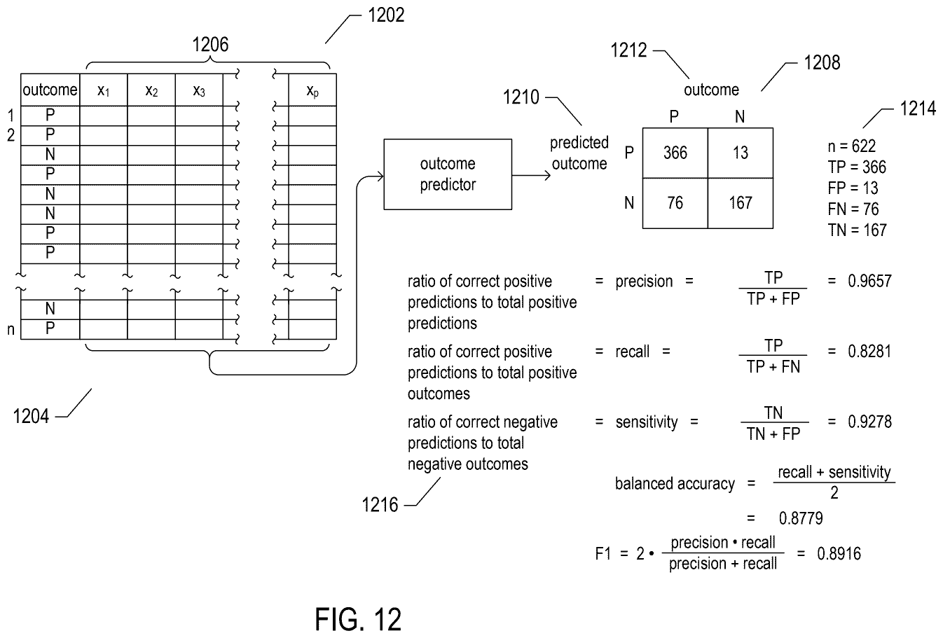

FIG. 12 illustrates various types of validation parameters that can be calculated for a particular neural-network-based prediction model. In the illustrated case, a data set used for validation 1202 includes an outcome column 1204 and multiple additional columns 1206 representing independent variables. Two types of outcomes are possible: (1) P, indicating a positive outcome; and (2) N, indicating a negative outcome. The neural-network prediction model has been trained to predict an outcome when an input generated from one or more of the independent-variable values in an observation are input to the neural-network prediction model. Each observation in the data set 1202 is used to generate a predicted outcome and the results are tabulated in table 1208. Each cell in the table is indexed by a predicted-outcome value, associated with the row that includes the cell, and the actual outcome value, associated with the column that includes the cell, as indicated by the vertical-axis label 1210 and the horizontal axis label 1212. Thus, for example, in 366 cases, the predicted positive outcome matched the actual outcome. The tabulated results can be alternatively expressed as numeric values for a number of result parameters, as shown in column 1214. The total number of validation predictions n is equal to 622. The number of true predicted positive outcomes, TP, is 366 while the number of false predicted positive outcomes, FP, is 13. The number of false predicted negative outcomes, FN, is 76 in the number of true predicted negative outcomes, TN, is 167. In a lower, right-hand portion of FIG. 12, expressions for a number of validation parameters 1216 are shown. These include the precision, recall, sensitivity, balanced accuracy, and F₁ parameters. Numerical values based on the results in table 1208 are also provided. These validation parameters are an example of the type of validation parameters that can be calculated for particular types of neural-network models.

The polynomial models and neural network models discussed above with reference to FIGS. 8A-9D and FIGS. 10-12 are only two examples of an enormous number of possible models and model variations. Additional types of widely used models include decision trees, random forests of decision trees, clustering models, and various different foundational models that provide the foundations of generative artificial intelligence technologies, including large-language models. Moreover, the number of parameters and characteristics that are used to specify any particular model may range from a few parameters, in the case of a simple polynomial model, to billions or more parameters, in the case of large-language models. The various phases of the model generation process, from data-set selection to shipping of one or more production models for incorporation into various types of systems and applications, may involve lengthy analysis and deliberations, generation of many intermediate results, and generation of documentation to capture the processes, decisions, and strategies used to generate models, and much, if not all, of the generated documentation and intermediate results needs to be stored for reliable and efficient retrieval in order to record the model-generation process to facilitate backtracking to various data-science-pipeline states in order to follow alternative model-generation processes and to facilitate subsequent validation and verification efforts. In other words, a large volume of information needs to be collected, organized, and stored, and relying only on manual and semi-manual operations to carry out the collection, organization, and storage of information has been found to be, at best, unreliable and imperfect and, at worst, dysfunctional.

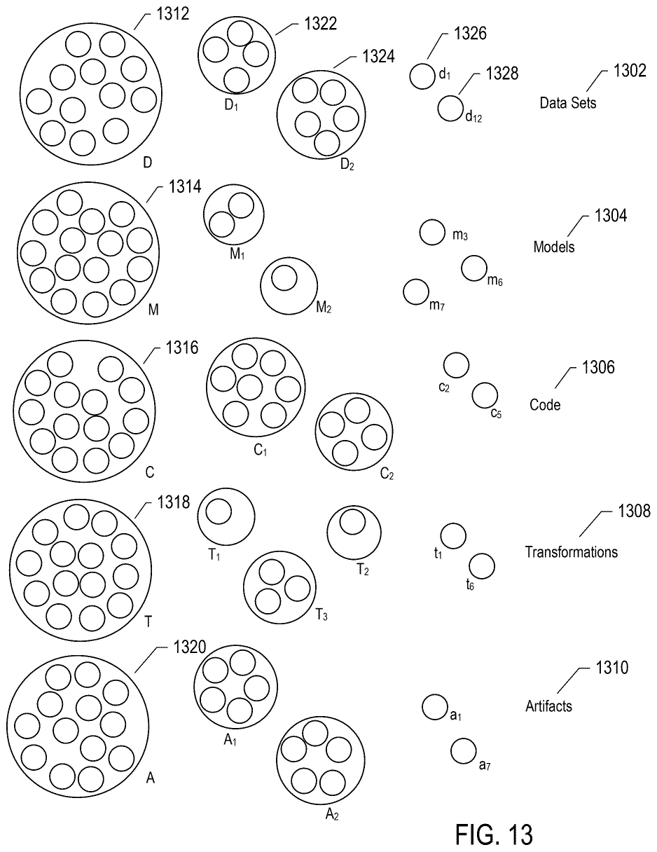

FIG. 13 illustrates five different classes of entities that are consumed and produced in a data-science pipeline, also referred to as a “model-generation process.” The five different classes include data sets 1302, models 1304, code 1306, transformations 1308, and artifacts 1310. Data sets, models, and code together comprise assets. A particular data-science pipeline is generally associated with a set of data sets 1312, a set of models 1914, a set of code extracts, such as portions of routines, routines, and programs 1316, a set of transformations 1318, and a set of artifacts 1320. Capital letters D, M, C, T, and A are used to represent the sets. Various different subsets of the sets may be considered at various different points in time, and are labeled by a capital letter and a numeric subscript, such as data-set subsets 1322 and 1324. Individual elements of the sets are labeled with lower-case letters and subscripts, such as data sets 1326 and 1328. Data sets and models have been discussed above. Code is simply a portion or all of a routine or program generally written in a high-level language, such as Python, R, C++, or another programming language. Data scientists generally express many of the model-generation steps in code that is executed in the one or more development environments that they use. Transformations are well-known operations carried out on data sets to produce result data sets, which are initially expressed in code. Transformations are identified in the code that is collected and analyzed by implementations of the currently disclosed methods and systems, as discussed below. Artifacts include many different types of outputs produced by data-sciences pipelines, including graphs and statistics, documentation, including narrative documentation and notes produced by data scientists, comments extracted from code, testing and validation results, analyses, and many other types of output data generated and stored during the model-generation process. One goal of the currently disclosed methods and systems is to automate collection and storage of artifacts. Another goal of the currently disclosed methods and systems is to record the model-generation process in a way that allows the state of a data-science pipeline to be reconstructed from the recorded information, as further discussed below.

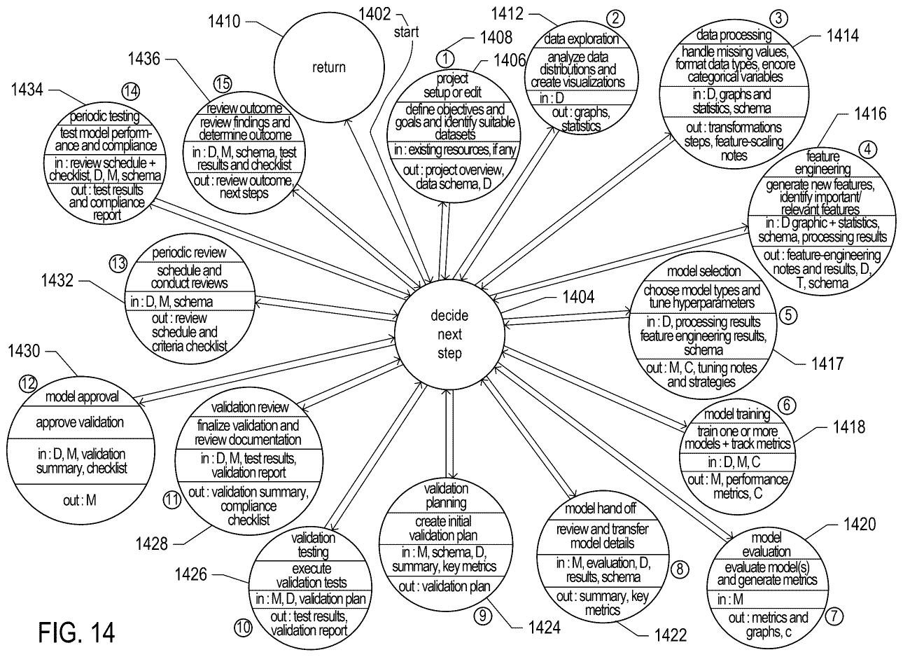

FIG. 14 shows a simplified state-transition diagram for typical data-science pipelines. Each disc represents a state and the arrows between discs represent state transitions. Initially, as represented by arrow 1402, the state of the data-science pipeline is represented by disc 1404, which represents a decision state in which a data scientist decides on a next step in the model-generation process. The remaining discs in FIG. 14 represent various different steps that can be carried out. In general, each of the steps includes a name or label, a brief explanation, an indication of inputs to the step, and an indication of outputs from this step. The steps are additionally labeled with circled numerals. Thus, for example, step 1 is represented by disc 1406 associated with the numeric label 1408. Step 1 is the only step that does not require an input, and is thus the only step that can be carried out in a newly created data-science-pipeline instance. Step 1 is a project-setup-or-edit step in which project objectives and goals are defined and suitable input data sets are identified. Outputs of step 1 may include a new or edited project overview, a new or edited data schema, and a new or modified set of data sets. The remaining steps 2 through 15, shown in a sequential order with a clockwise orientation with respect to the first step, represent a logical sequence of steps that may be undertaken in a data-science-pipeline instance. However, any particular data-science-pipeline instance may include many loops through, and iterations of, individual steps and subsets of the 15 steps shown in FIG. 14. Thus, for example, the outputs of a first execution of a step may be later modified in a second iteration of the step. A final step 1410 represents termination of a data-science-pipeline instance. Step 2 (1412) is a data-exploration step in which one or more of the current data sets are analyzed and various graphs and statistics that represent the results of the analysis are produced. Step 3 (1414) is a data-processing step in which data sets are altered to account for various missing values, to standardize and format various values, and to provide a standard encoding of categorical values, among other types of alterations. Step 4 (1416) is a feature-engineering step in which new features may be added to data sets and features that are relevant and/or important for model generation may be identified. Step 5 (1417) is a model-selection step in which one or more model types are selected for generation based on the objectives and goals of the project and the various different types of data sets that are available. Step 6 (1418) as a model-training step. Step 7 (1420) is a model evaluation step. Step 8 (1422) is a model-handoff step in which one or more models are prepared for transfer to a validation-and-testing organization. Step 9 (1424) is a validation-planning step in which the validation-and-testing organization develops a validation plan. Step 10 (1426) is a validation-and-testing step in which one or more models are validated and/or tested. Step 11 (1428) is a validation-review step. Step 12 (1430) is a model-approval step. Step 13 (1432) is a periodic-review step that may be undertaken at various points in time to schedule periodic step 14 (1434 is a periodic-testing step carried out according to a periodic-review schedule. Step 15 (1436) is a review step that reviews the results of periodic testing.

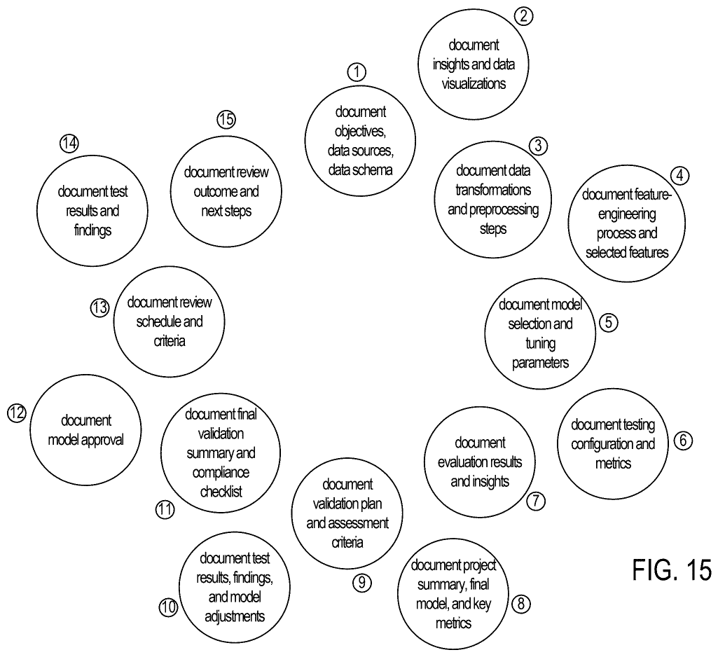

FIG. 15 illustrates the documentation that is desirably produced in each of the data-science-pipeline steps shown in FIG. 14. Each of the data-science-pipeline steps is again represented by a disk, with the discs arranged identically in FIG. 15 to the arrangement of the discs in FIG. 14. It can be appreciated, from FIG. 15, that extensive documentation is desired for all of the steps in a data-science pipeline. Currently, much of this documentation is manually produced by data scientists and the production of the documentation is the responsibility of individual data scientists. As a result, a data scientist may fail to produce a desired level of documentation at a desired quality level. This may result from simple oversight, time pressure, disorganization, inability to audit the work, inability to prove adherence to internal policies and regulations, and other reasons, but failure to document can lead to serious downstream problems. Another problem that arises is that the documentation and products associated with a data-science pipeline may not be stored in a logical fashion, resulting in lost or inaccessible documentation, intermediate results, and products. While documentation is one problem, keeping track of, and reliably storing and archiving, various additional assets and artifacts produced by a data-science pipeline is also a significant problem. As discussed above, it may be necessary to reproduce intermediary data-pipeline states in order to follow different model-generation paths from those reproduced states and/or in order to analyze and validate the processes represented by a sequence of states, and thorough documentation greatly facilitates the reproduction of intermediary data-pipeline states.

FIGS. 14 and 15 show merely one example of a data-science-pipeline state-transition diagram. Many alternative state-transition diagrams can be prepared to illustrate the same or different data-science pipelines. For example, the overall process can be partitioned into different steps and different data-science pipelines may include additional, fewer, or different steps. In general, a data-science pipeline involves many different types of subprocesses and tasks and the subprocesses and tasks are generally complex and involve many different considerations and decisions. As a result, the information that needs to be recorded and stored to document the model-generation process and to allow for reconstructing the state of the data-science pipeline at selected points in time is correspondingly complex and voluminous.

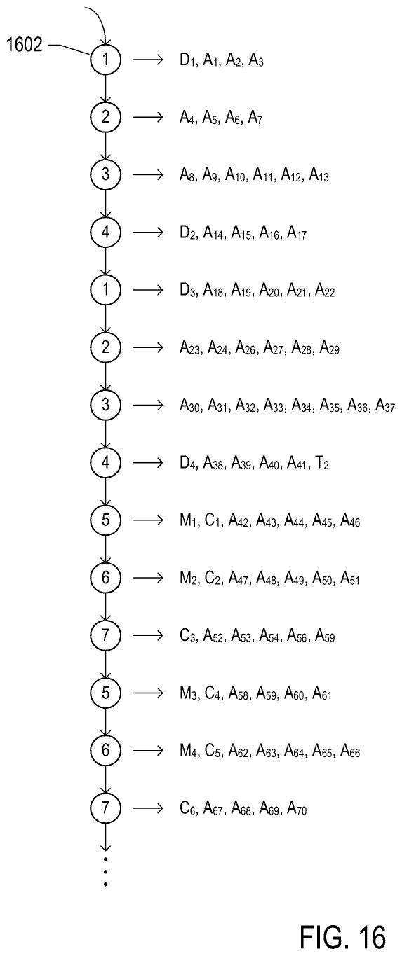

FIG. 16 illustrates a portion of a data-science-pipeline instance. The data-science pipeline can be thought of as being produced by a series of the state transitions shown in the state-transition diagram illustrated in FIG. 14. The series of state transitions generates a linear sequence of steps, beginning with step 1 (1602). Each step may produce various results, including assets, such as data sets, models, and code, transformations, and artifacts. The intermediary results may be newly created assets and artifacts and/or modified versions of previously created assets. One significant problem that is addressed by the currently disclosed methods and systems is that of keeping track of the results produced by a data-science-pipeline instance in a way that allows the logical state of the data-science pipeline instance to be reconstructed for any particular point in time and that allows particular assets and artifacts to be quickly and efficiently identified and retrieved from storage.

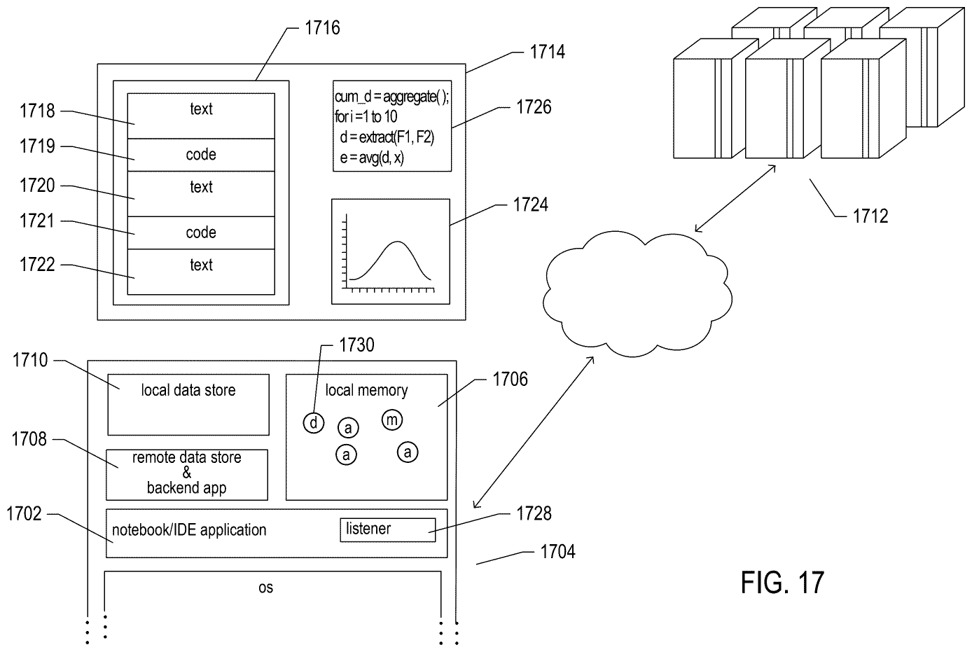

FIG. 17 illustrates a development environment used by a data scientist for carrying out tasks associated with a data-science pipeline. Examples of development environments may include Jupyter notebooks and various different integrated development environments (“IDEs”). The development environment includes an application 1702 running within a computer 1704 that uses various computational resources, including local memory 1706, access to remote data stores and remote computational entities 1708, and a local data store 1710, such as a portion of a solid-state disk (“SSD”). The computer 1704 is generally connected through a local network and wide-area networks to various external computational entities, including data centers and cloud-computing facilities 1712. The development environment provides a rich graphical user interface (“GUI”) 1714 to the data scientist, including a main document 1716 comprising text and code cells 1718-1722 along with additional windows that display graphs and statistics, such as window 1724, and additional windows, such as window 1726, for displaying execution of code as in an IDE. The development environment may include many additional types of features and display windows. The currently disclosed implementations of the currently disclosed methods and systems rely on a listener component 1728 within, or associated with, the development-environment application for detecting data-collection events, locally processing collected data, and forwarding processed collected data to a backend component that maintains a database of references to assets and artifacts, and often the assets and artifacts themselves. The listener uses development-environment utilities, or other means, to identify all, portions of, and/or references to assets and artifacts stored in the local memory, such as dataset 1730, and additionally identifies references to assets and artifacts in code cells and other development-environment entities to generate consistent data-science-pipeline-state snapshots for forwarding to the backend component, as discussed below.

In certain implementations, distinct listener processes may be deployed in different environments. For example, a development listener may capture identifiers of code cells, dataset usage, transformation steps, and intermediate artifacts, while a validation listener may capture metadata specific to validation activities, such as validation-suite identifiers, evaluation metrics with defined thresholds, dataset partitions, random seeds, and results of test procedures. These separate listener processes allow the system to capture the entirety of the model development exercise, while ensuring that both types of metadata are recorded as entity descriptors in the centralized database. A development-environment listener may collect and store source-code identifiers, code-cell identifiers, commit identifiers, dependency manifests, runtime or environment versions, parameter or hyperparameter values, dataset identifiers and schema information, transformations, and artifact checksums. A model-validation listener may collect and store source-code identifiers, code-cell identifiers, commit identifiers, dependency manifests, runtime or environment versions, validation-suite identifiers, evaluation metrics with threshold definitions, cross-validation fold identifiers or seed values, test descriptors, and artifact checksums, as entity descriptors.

### The Currently Disclosed Systems and Methods

A main component of the currently disclosed methods and systems is a centralized database that stores entity descriptors for each version of each of the assets and artifacts associated with a model-generation project or data-science-pipeline instance. The centralized database includes sufficient information to reconstruct a representation of the state of the data-science-pipeline instance, or model-generation project, at any selected point in time. The centralized database also provides the information needed to quickly and efficiently identify and retrieve any of the assets and artifacts associated with a data-science-pipeline instance or model-generation project.

FIG. 18 illustrates an entity-descriptor that represents a data-science-pipeline asset, transformation, or artifact. There are, of course, many different possible ways to implement the centralized database and data-storage entities used to store and organize information within the centralized database. The entity descriptor shown in FIG. 18 is one possible logical implementation of a basic information-storage entity in the centralized database. The entity descriptor 1802 generally includes a header 1804, an entity-specific header 1806, and entity metadata 1808. The header may contain an entity identifier 1810, an indication of the type of entity represented by the entity descriptor 1811, a timestamp 1812, a version indication 1813, and a checksum 1814 used to quickly compare two entity descriptors representing the same asset, transformation, or artifact in order to detect edits or changes to one or both entity descriptors. Broken section 1815 indicates a possibility of additional fields in the header, and this convention is used throughout the current document. The entity-specific header may include a name 1816, a subtype indication 1817, and a file name, URL, or other reference to a stored-data implementation of the entity. A function “meta” can be applied to an entity descriptor to generate a formatted representation of the metadata contained in the entity descriptor, as indicated by expression 1820. A lower portion of FIGS. 18, 1822, includes lists of various different types of metadata that may be included in the entity descriptor for the five different classes of entities associated with data-science-pipeline instances or model-generation projects. For example, the metadata included in an entity descriptor for a data set may include information for identifying a database, file, or other computational entity from which the data set can be extracted, such as table names and column names for relational database tables that store the data of the data set, references to, or entity identifiers for, artifacts generated from that data set represented by the entity descriptor, and other such information. Metadata associated with an entity descriptor representing a model may include an indication of a general algorithm, the values of various model parameters, such as numerical values of coefficients for polynomial models, the number of node levels, the number of nodes in each level, the activation function, and input and output vector specifications for neural-network models, references to, or entity identifiers for, training datasets used to train the model, references to, or entity identifiers for, artifacts storing metrics and statistics generated during evaluation of the model, and other such information. The metadata for an entity descriptor representing code may include references to, or entity identifiers for, various different inputs to the code, references to external code libraries, routines, and processes called by the code, references to, or entity identifiers for, artifacts storing comments extracted from the code, and other such information. The metadata contained in an entity descriptor representing a transformation may include references to, or entity identifiers for, entity descriptors representing input and output data sets, indications of one or more logical operations that together comprise the transformation, and other such information. The metadata in an entity descriptor that represents an artifact may include an indication of the type of artifact, references to, or entity identifiers for, data sets or models described by the artifact, references to, or entity identifiers for, the code that generated the artifact, and various types of output content, including comments, graphs, statistics, testing and validation results, data-scientist notes and observations, and other such information.

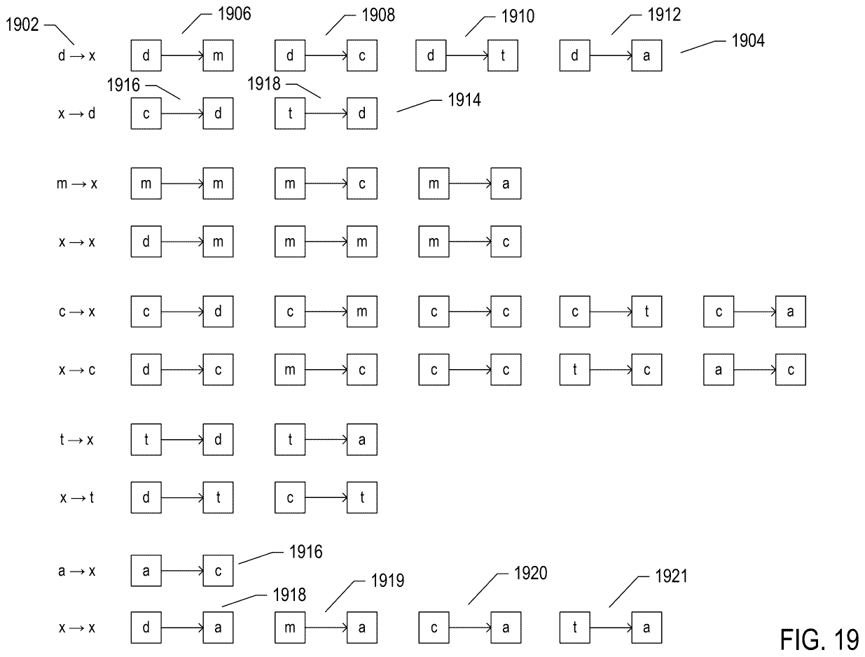

The entity descriptors of the centralized database, such as the entity descriptor shown in FIG. 18, include the information needed to interconnect the entity descriptors, or graph nodes for the entities represented by the entity descriptors, into a graph that represents both the history of the entities within a data-pipeline instance or model-generation process and the state of the data-pipeline instance or model-generation process at each point in time. FIG. 19 illustrates the various different types of edges in such a graph as well as the types of entity descriptors connected by each of these edges. Each row in FIG. 19 illustrates edges between nodes of one particular type and other nodes, as indicated in column 1902, where “x” represents one or more node types and the arrows represent directed edges. For example, row 1904 shows the possible directed edges emanating from a node representing a data set. A directed edge may emanate from a data-set node to a node representing a model 1906. This may indicate that the data set was used to train the model. A data-set node may be linked through a directed edge to a code node 1908, the directed edge indicating that the data set was represented by a variable in the code or input to the code, as one example. A data-set node may be linked through a directed edge to a transformation node 1910, indicating that the transformation acted on the data set or that, in other words, the data set was input to the transformation operation. A data-set node may be linked through a directed edge to an artifact node 1912, indicating, as an example, that the artifact contains information generated with respect to the data set. Row 1914 shows the possible directed edges from various nodes to a data-set node. For example, a code node may be linked through a directed edge to a data-set node 1916, the directed edge representing the fact that the code produced or output the data set. A transformation node may be linked through a directed edge to a data-set node 1918 to represent, for example, that the operation represented by the transformation node output the data set as an operation result. The remaining rows in FIG. 19 use the same illustration conventions to indicate the additional pairs of node types that can be interconnected by a directed edge. For example, an attribute may be input to a particular code portion 1916 and an attribute may be generated to describe, or to contain results related to, a data set 1918, a model 1919, code 1920, or a transformation 1921. The information that specifies the edges in the graph is contained in the entity descriptors that represent assets, models, code, transformations, and artifacts. In general, at least a portion of the entity descriptors in the centralized database, including entity-descriptors representing datasets, transformations, and models, can be used to generate a directed, acyclic graph that represents the lineage and pathways from input data sets to models and other products of a data-science pipeline, with artifacts generally representing outputs generated from individual assets and transformations or combinations of assets and transformations.

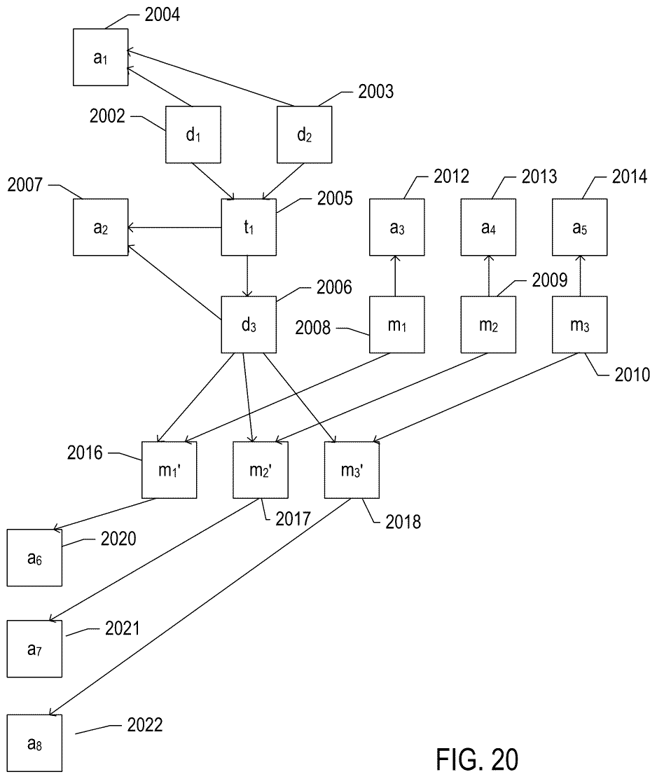

FIG. 20 shows a small example graph generated from entity descriptors that describe assets, transformations, and artifacts associated with a model-generation project. Two data sets 2002-2003 are selected as inputs to the model-generation process. An artifact 2004 containing documentation input to the development environment by data scientists contains information about the two data sets and the selection process. The two data sets are combined in a join-like operation represented by transformation node 2005. The join operation produces a result data set 2006 and an artifact 2007 is generated to contain information about the transformation and the decision to use the transformation to produce data set 2006. Three different models 2008-2010 are selected, with documentation describing the selection process for each model incorporated into artifacts 2012-2014. All three models are trained using data set 2006 to produce the three corresponding trained models 2016-2018. Documentation related to these three trained models, including evaluation metrics, is incorporated into three corresponding artifacts 2020-2022. Again, this graph can be generated from the information stored in the entity descriptors representing the data sets, transformation, and artifacts. The state of the model-generation process at any point in time is described by the nodes with timestamps equal to or less than the particular point in time and any edges connecting them.

In addition to enabling reproducibility and debugging, the graph provides structured information suitable for compliance reporting. For example, entity descriptors may include dataset identifiers and schema versions, hyperparameter values, training and validation splits, random seeds, evaluation metrics with associated thresholds, and references to source-code commits or transformations. These items provide evidence of how a model was trained, tested, and validated at a particular point in time. Entity descriptors can therefore be queried to produce input to compliance documents, such as model cards, validation reports, and audit logs, or to point auditors directly to specific evidentiary records, ensuring that regulatory requirements are met.

The currently disclosed methods and systems allow a data scientist to initiate automated recording of the use and production of data sets, models, code, transformations, and artifacts at a particular point in time, to aggregate and process the recorded information, and to forward the recorded information to a backend for incorporation into the centralized database at a subsequent point in time. A data scientist thus chooses time periods within the model-generation process for recordation. A data scientist may choose to not record information for certain portions of the model-generation process, such as experimental steps from which the data scientist does not expect meaningful or useful results.

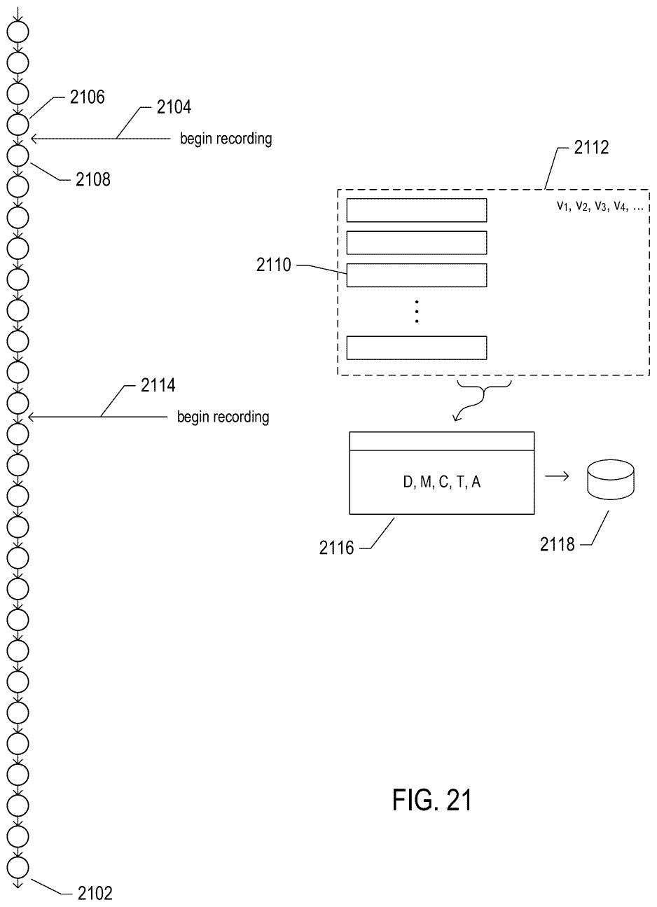

FIG. 21 illustrates initiation and termination of data collection by a data scientist using the currently disclosed methods and systems. The column of successive steps 2102 represents various steps undertaken by the data scientist during a lengthy time interval. As indicated by arrow 2104, the data scientist initiates data collection at the completion of step 2106 and prior to undertaking step 2108. This notifies the listener process to detect data-collection events, such as execution of code cells in the development environment, and to record information with regard to the current state of the model-generation process or, in particular, to that portion of the model-generation process currently being conducted by the data scientist. The recorded information may include references to, or indications of, various different data sets, models, code, and artifacts in code executed within a development environment and may additionally include other information, such as textual documentation entered into text cells of a development environment by the data scientist. Rectangles, such as rectangle 2110 in FIG. 21, represent data collected in response to each of multiple data-collection events. In addition, references to, and data representations of, assets and artifacts stored in memory, such as variables manipulated by code execution 2112, are identified and used for processing autolog directives. At a later point in time, represented by arrow 2114, the data scientist inputs an autolog directive to the development environment which commands the listener process to process the collected data and package the processed collected data into an autolog-information package 2116 that is then sent to the backend for additional processing and eventual propagation to the centralized database 2118, as further discussed below.

In certain implementations, data collection and logging may occur constantly, with data-scientist-initiated data collection and data-scientist-initiated autologging generating higher-level data stored in the centralized database with fewer access constraints compared to the data that is not collected and stored during data-scientist-initiated recording. There are many possible approaches to specifying and controlling the amount of data collected and stored and the times periods when data is collected and stored by the currently disclosed methods and systems.

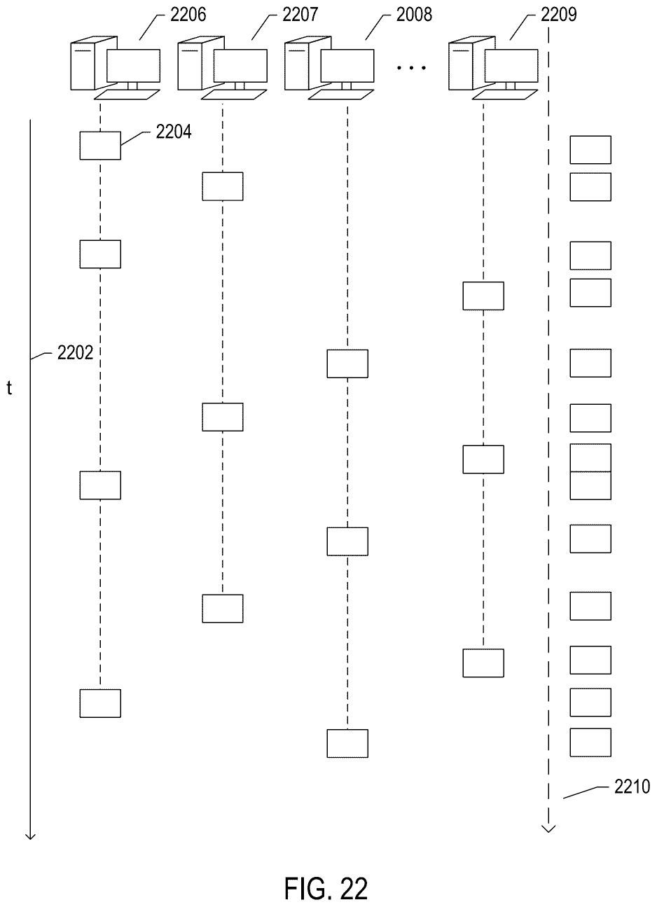

FIG. 22 illustrates the parallel generation of autolog-information packages by multiple data scientists using multiple different development environments. Arrow 2202 is a timeline representing the passage of time in the downward, vertical direction. Rectangles, such as rectangle 2204, represent generation and sending of autolog-information packages to the backend by each of four different data-scientists computer systems 2206-2209. These autolog-information packages can then be projected rightward onto a timeline, represented by dashed arrow 2210, to generate a time-ordered series of autolog-information packages received by the backend. The cumulative state of the model-generation process at a particular point in time is represented by the data contained in the autolog-information packages received by the backend up to the particular point in time. Thus, the currently disclosed methods and systems allow multiple data scientists using multiple different development environments to generate autolog-information packages that are transferred to the backend for incorporation into a centralized database that represents the combined efforts of the multiple data scientists during the model-generation process.

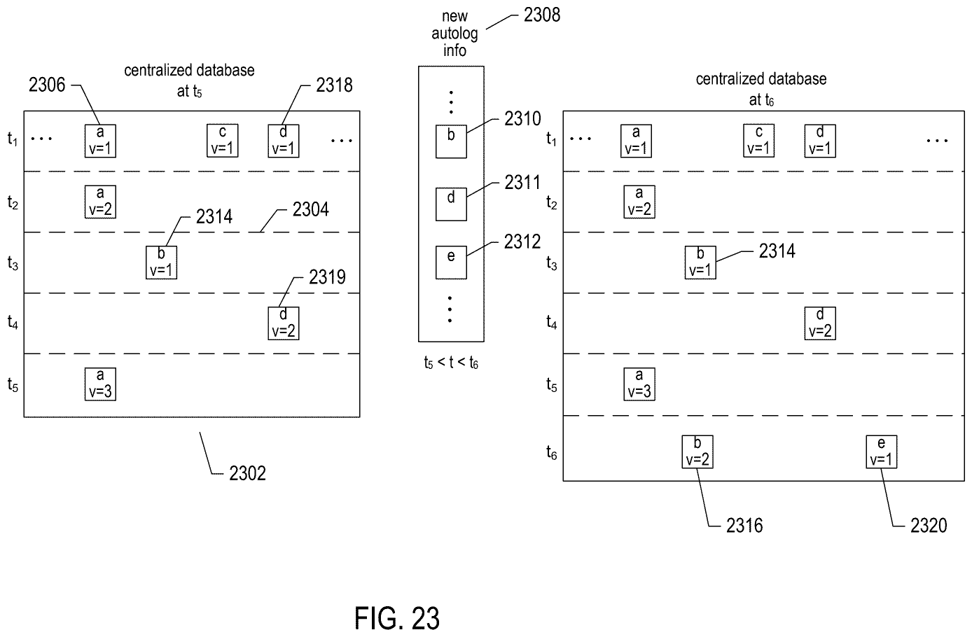

FIG. 23 illustrates update of the centralized database using information contained in a newly received autolog-information package. Rectangle 2302 represents a portion of the data currently stored in a centralized database. The currently stored data is accumulated from autolog-information packages previously received at times t₁, t₂, t₃, t₄, and t₅. The contents of the centralized database shown in rectangle 2302 are partitioned according to the times at which the information was received, with dashed horizontal lines, such as line 2304, indicating the temporal partitions. Of course, the centralized database is not physically partitioned. The partitioning is shown in FIG. 23 to illustrate the data accumulated at different points in time. The entity descriptors stored in the centralized database are represented by smaller rectangles, such as smaller rectangles 2306. Each smaller rectangle is labeled with a lower-case-letter indication of the entity represented by the entity descriptor as well as an indication of the version number contained in the entity descriptor. Rectangle 2308 represents a newly arrived autolog-information package. The newly arrived autolog data package contains three entity descriptors 2310-2312. The newly arrived autolog data package is received at a time t later than t₅ but earlier than a time t₆ when information contained in the newly arrived autolog data package is incorporated, by the backend, into the centralized database. The first entity descriptor in the newly arrived autolog data package, entity descriptor 2310, represents an entity b which is currently represented by entity descriptor 2314 already stored in the centralized database. Therefore, since the contents of entity descriptor 2310 differ from the contents of entity descriptor 2314, a new entity descriptor 2316 is stored in the centralized database with a version number greater than the version number of entity descriptor 2314. The second entity descriptor in the newly arrived autolog data package, entity descriptor 2311, represents the entity d which is currently represented by entity descriptors 2318-2319 already stored in the centralized database. However, comparison of the contents of entity descriptor 2311 with the contents of entity descriptor 2319 reveals that entity descriptor 2311 contains the very same information as contained in already stored entity descriptor 2319. Therefore, the arrival of entity descriptor 2311 in the newly arrived autolog data package does not result in any additional information stored in the centralized database. Finally, the third entity descriptor in the newly arrived autolog data package, entity descriptor 2312, represents an entity e which is not currently represented by an entity descriptor in the centralized database. Therefore, entity descriptor 2312 is stored in the centralized database as entity descriptor 2320 with a version number of 1.

There are many possible optimizations related to data-collection, data storage, and the centralized database. For example, only differences in the data contained in entity descriptors describing a particular asset or artifact with different versions may be stored, rather than storing a complete, and perhaps largely redundant, entity descriptor for each successive version of the entity descriptor. Similarly, differences, rather than entire complete information may be transmitted, by the listeners to the backend when the listeners can determine that certain of the collected information may be redundant. Furthermore, entity descriptors may reference large data sets stored in different systems and/or databases rather than redundantly store that information in the centralized database, in certain implementations. Much of the stored data may be compressed and may be periodically archived, in certain implementations.

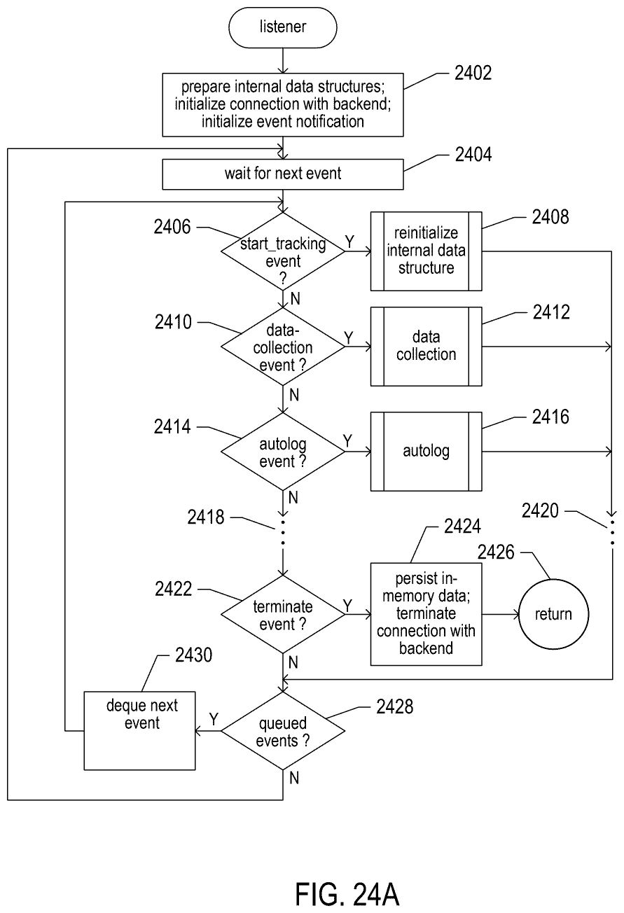

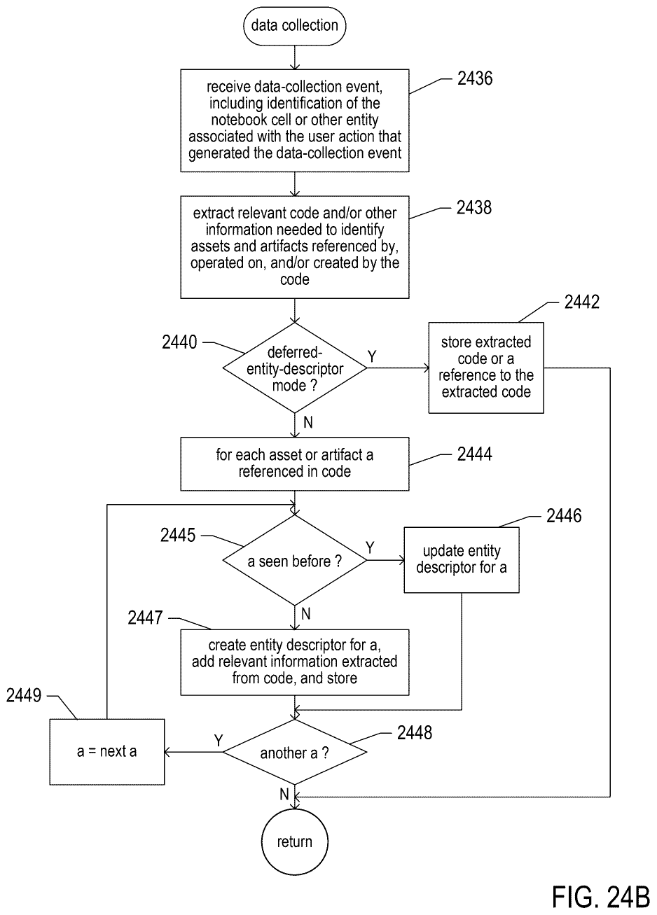

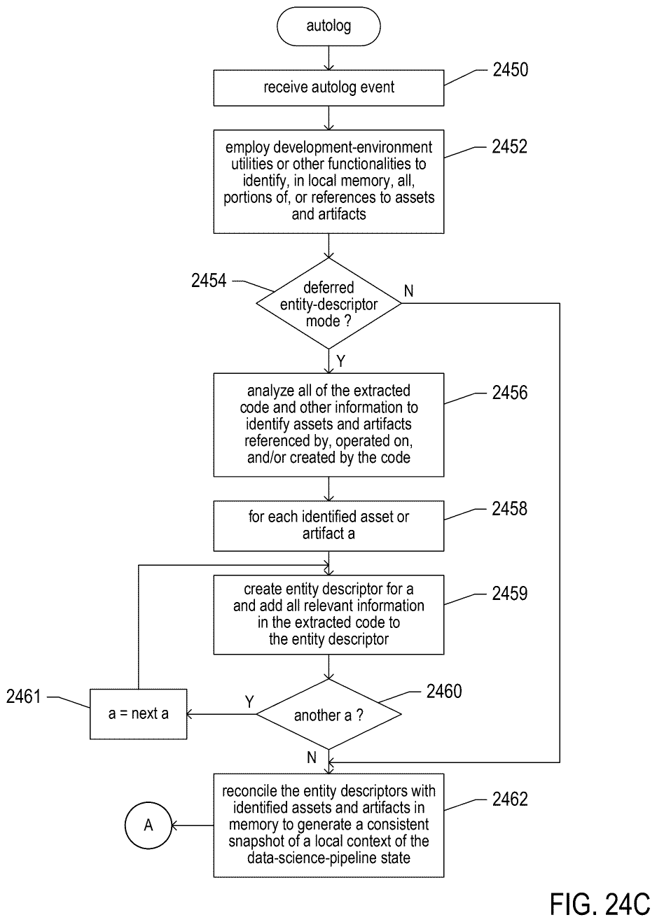

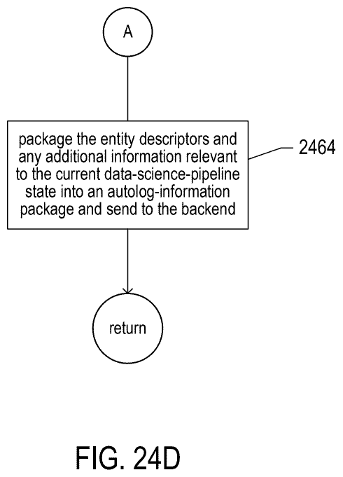

FIGS. 24A-D provide control-flow diagrams that illustrate operation of the listener. As discussed above, with reference to FIG. 17, the listener (1728) is included in, or launched by, a development-environment application. In step 2402 of FIG. 24A, upon being launched, the listener prepares internal data structures, initializes a connection with the backend, and initializes event notification within the development environment in order to detect certain data-collection events and other events that occur in the development environment. In step 2404, the listener waits for the occurrence of a next event. When the next event is a start-tracking event, as determined in step 2406, where the start-tracking event corresponds to initiation of data recording, as represented by arrow 2104 in FIG. 21, the listener calls a handler to reinitialize internal data structures to prepare for subsequent data collection, in step 2408. Otherwise, when the event is a data-collection event, as determined in step 2410, with the data-collection event corresponding to execution of a code cell or entry of text into a text cell in the development environment, or some other event indicating that the listener should collect and locally store information from the development environment, the listener calls a data-collection handler, in step 2412. When the next-occurring event is instead an autolog event, as determined in step 2414, where the autolog event corresponds to arrow 2114 in FIG. 21, the listener calls an autolog handler in step 2416. Ellipses 2418 and 2420 indicate that the listener event loop shown in FIG. 24A may detect and handle additional types of events. Upon detection of a termination event, in step 2422, the listener persists in-memory data that may be subsequently needed and terminates the connection with the backend, in step 2424, and then terminates, in step 2426. When there are no additional queued events for handling, as determined in step 2428, control flows back to step 2404 where the listener waits for the occurrence of a next event. Otherwise, in step 2430, a next event is dequeued for handling and control then returns to step 2406.

FIG. 24B provides a control-flow diagram for the data-collection handler called in step 2412 of FIG. 24A. In step 2436, the data-collection handler receives a data-collection event, which may include an identifier for a notebook cell or other development-environment entity associated with the user action that generated the data collection event to facilitate data collection. The received data-collection event may include additional information. In step 2438, the data-collection handler extracts relevant code and/or other information needed to identify assets and artifacts referenced by, operated on, created by, modified by, or otherwise manipulated by the development-environment entity identified in the received data-collection event. When the listener is operating in a deferred-entity-descriptor mode, as determined in step 2440, the extracted relevant code and/or other information or a reference to the extracted relevant code and/or other information is stored in local memory, in step 2442. Otherwise, in the for-loop of steps 2444-2449, each asset, artifact, or other information a referenced by or included in the code is considered. In step 2445, the data-collection handler determines whether the asset, artifact, or other information a has been previously identified during the current data-recording interval. If so, an entity descriptor created for a is updated, as necessary, using the currently extracted relevant code and/or other information in step 2446. Otherwise, in step 2447, a new entity descriptor or a is created in local memory and the currently extracted relevant code and/or other information is used to store values of one or more fields of the newly created entity descriptor. When there is another a to consider, as determined in step 2449, a next iteration of the for-loop of steps 2444-2449 is undertaken. The data-collection handler returns either at the completion of the for-loop of steps 2444-2449 or following step 2442. Note that, in deferred-entity-descriptor mode, entity descriptions are created only following an autolog event, as discussed below. Otherwise, entity descriptors are immediately created when a not-yet-seen asset or artifact is first identified during the current data-recording interval. Deferred-entity-descriptor mode may be more computationally efficient, but non-deferred-entity-descriptor mode may allow for finer-grain detection of various tasks and operations carried out in the context of a data-science-pipeline instance.

FIGS. 24C-D provides a control-flow diagram for the autolog handler called in step 2416 of FIG. 24A. In step 2450, the autolog handler receives an autolog event. In step 2452, the autolog handler employs development-environment utilities or other functionalities to identify, in local memory, all, portions of, or references to assets and artifacts. When the listener is operating in deferred-entity-descriptor mode, as determined in step 2454,
the autolog handler, in step 2456, analyzes the previously extracted relevant code and/or other information to identify assets and artifacts referenced by, operated on, created by, modified by, or otherwise manipulated by the development-environment entity identified in the received data-collection event. In the for-loop of steps 2458-2461, each asset, artifact, or other information a referenced by or included in the code is considered. In step 2459, a new entity descriptor for a is created and the extracted relevant code and/or other information is used to store values in one or more fields of the newly created entity descriptor. When there is another a to consider, as determined in step 2449, a next iteration of the for-loop of steps 2458-2461 is undertaken. Following completion of the for-loop of steps 2458-2461 or when the listener is not operating in deferred-entity-descriptor mode, as determined in step 2454, the autolog handler, in step 2462, the entity descriptors created in the current data-recording interval are reconciled with the assets and artifacts or references to assets and artifacts that were identified in step 2452. For example, the entity descriptors for assets and artifacts that may have been referenced in portions of the code that were not executed and that therefore were not identified in step 2452 may be deleted. As another example, assets and artifacts identified in step 2452 but not found in the extracted code may correspond to assets and artifacts that were initially referenced in the code but, due to code changes, no longer are and therefore are no longer relevant. The corresponding entity descriptors may therefore be removed. Thus, the autolog handler uses the available collected data and the information extracted from local memory to prune or supplement the entity descriptors so that, in aggregate, they faithfully represent the current state of the data-science-pipeline instance. Finally in step 2464, in FIG. 24D, the autolog handler includes the entity descriptors and any additional collected relevant information into an autolog-information package that the autolog handler transmits to the backend component.

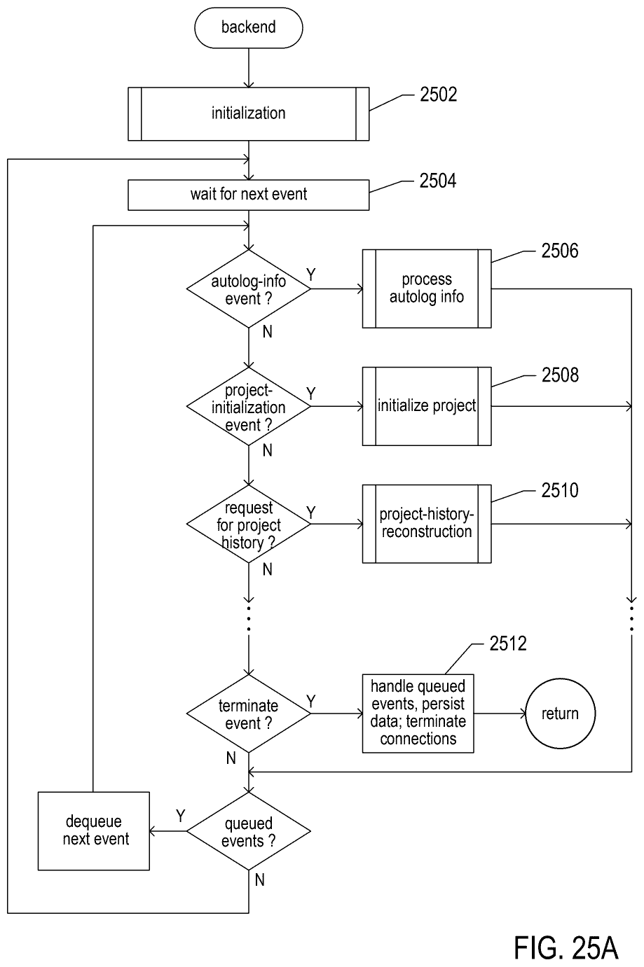

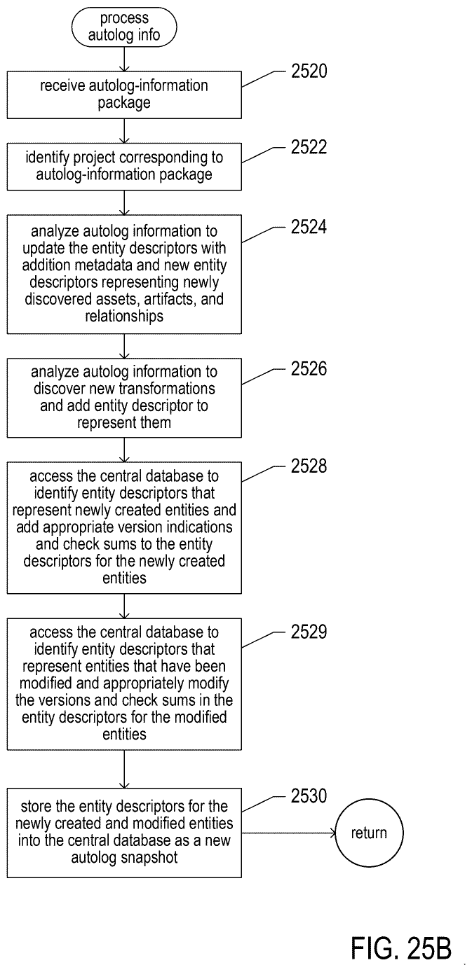

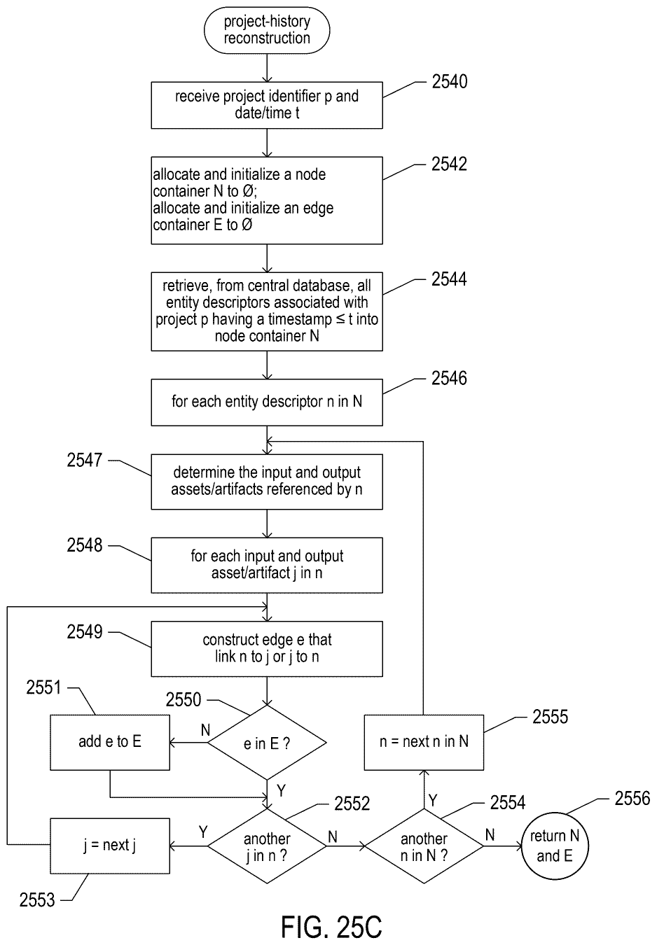

FIGS. 25A-C provide control-flow diagrams that illustrate operation of the backend. FIG. 25A shows an event loop for the backend much like the event loop for the listener shown in FIG. 24A. The backend is initialized, in step 2502, and then waits for the occurrence of a next event in step 2504. When an autolog-information event is detected or received, a process-autolog-information handler is called in step 2506. When a project-initialization event is detected or received, an initialize-project handler is called in step 2508. When a request-for-project-history event is received or detected, a project-history-reconstruction handler is called in step 2510. Finally, a termination event results in data persistence and connection termination, in step 2512, before termination of backend execution.

FIG. 25B provides a control-flow diagram for the process-autolog-information handler called in step 2506 of FIG. 25A. In step 2520, the process-autolog-information handler receives an autolog-information package from a listener. In step 2522, the project corresponding to the received autolog-information package is identified using information contained in the autolog-information package. In step 2524, the process-autolog-information handler analyzes the autolog information to update the entity descriptors contained in the autolog-information package with additional metadata and adds additional entity descriptors representing assets, artifacts, and relationships detected by the analysis. The new entity descriptors may include artifact descriptors containing documentation included in the autolog-information package. The documentation may be enhanced by using documentation templates and by correlating the documentation with additional information included in the autolog-information package. In step 2526, the autolog information is analyzed to discover transformations and add entity descriptors to represent the discovered transformations. Finally, in steps 2528-2530, the processed autolog information is used to update the centralized database, as discussed above with reference to FIG. 23. Many of the steps carried out by the process-autolog-information handler are implemented using one or more large-language models.

FIG. 25C provides a control-flow diagram for the project-history-reconstruction handler called in step 2510. In step 2540, the project-history-reconstruction handler receives a project identifier p and the date/time t. In step 2542, the project-history-reconstruction handler allocates and initializes an empty node container N and an empty edge container E. In step 2544, the project-history-reconstruction handler retrieves, from the centralized database, all entity descriptors associated with project p having timestamps less than or equal to t and adds corresponding nodes for the retrieved entity descriptors into node container N. In an outer for-loop of steps 2546-2555, the project-history-reconstruction handler considers each node n in the node container N. In step 2547, the input and output assets and artifacts referenced by the currently considered node n are determined. In an inner for-loop of steps 2548-2553, each node j contained in N corresponding to one of the assets and artifacts identified in step 2547 is considered. In step 2449, an edge e that links node n to node j or node j to node n is constructed. When edge e is not already contained in the edge container E, as determined in step 2550, the edge is added to the edge container in step 2551. Upon completion of the outer and inner for-loops, the node and edge containers are returned in step 2556. The contents of these two containers can be used to construct a graph, such as the graph illustrated in FIG. 20.

The present invention has been described in terms of particular embodiments, it is not intended that the invention be limited to these embodiments. Modifications within the spirit of the invention will be apparent to those skilled in the art. For example, any of many different implementations of the currently disclosed methods and systems can be obtained by varying various design and implementation parameters, including modular organization, control structures, data structures, hardware, operating system, and virtualization layers, and other such design and implementation parameters.

1. A method that collects and stores documentation and intermediate results during a computational-model-generation process and that subsequently provides a history of the steps carried out, computational entities consumed, and intermediate results produced during the computational-model-generation process and reconstructs a specified state of the computational-model-generation process at a specified time point, the method comprising:
incorporating a listener process within, or associating the listener process with, a development-environment application that implements a development environment, incorporated in a first computer system, that manages all or a portion of the computational-model-generation process;
responding, by the listener process during the computational-model-generation process, to a data-collection event by collecting and storing information related to the steps carried out, computational entities consumed, and intermediate results produced during a portion of the computational-model-generation process;
responding, by the listener process during the computational-model-generation process, to an autolog event by retrieving stored information related to the steps carried out, computational entities consumed, and intermediate results produced during a portion of the computational-model-generation process, packaging the retrieved stored information into an autolog information package, and forwarding the autolog information package to a backend process incorporated in a second computer system;
receiving, by the backend process, the autolog information package, analyzing the information contained in the autolog information package in order to update information, stored in a centralized database, that represents the steps carried out, computational entities consumed, and intermediate results produced during the computational-model-generation process; and
receiving, by the backend process, a request for a history and/or state of the computational-model-generation process from a requesting entity, reconstructing the history of the computational-model-generation process using information stored in the centralized database and/or determining a state of the computational-model-generation process at a specified point in time, and returning the history and/or determined state to the requesting entity.

2. The method of claim 1 wherein the steps carried out, computational entities consumed, and intermediate results produced during the computational-model-generation process include:
one or more data sets;
one or more computational models;
one or more code extracts, such as portions of routines, routines, and programs;
one or more transformations carried out on data sets to produce transformation-generated data sets; and
one or more artifacts, each artifact comprising data generated during the computational-model-generation process, including graphs, statistics, metrics, documentation, comments extracted from code, testing and validation results, and analyses.

3. The method of claim 2 wherein information collected and stored by the listener process for a data set, computational model, code extract, transformation, or artifact and subsequently stored in the centralized database by the backend process is incorporated into an entity descriptor.

4. The method of claim 3 wherein an entity descriptor is a data structure stored in the memory of a computer system and/or in a data-storage device or appliance that includes:
a header, containing
an entity identifier,
an indication of the type of entity represented by the entity descriptor,
a timestamp,
a version indication, and
a checksum; and
entity metadata, which includes entity-specific information corresponding to the data set, computational model, code extract, transformation, or artifact represented by the entity descriptor.

5. The method of claim 4 wherein the entity metadata contained in an entity descriptor corresponding to a data set includes one or more of:
the data set;
information that identifies a database, file, or other computational entity from which the data set can be extracted; and
references to, or entity identifiers for, artifacts generated from the data set.

6. The method of claim 4 wherein the entity metadata contained in an entity descriptor corresponding to a computational model includes one or more of:
an indication of, or reference to, a computational method or the computational model;
the values of various model parameters;
a number of node levels;
a number of nodes in each level of the computational model;
an activation function;
input and output vector specifications for neural-network and large-language models;
references to, or entity identifiers for, training datasets; and
references to, or entity identifiers for, artifacts storing metrics and statistics generated during evaluation of the computational model.

7. The method of claim 4 wherein the entity metadata contained in an entity descriptor corresponding to a code extract includes one or more of:
the code extract;
references to, or entity identifiers for, the code extract;
references to, or entity identifiers for, inputs to the code;
references to external code libraries, routines, and processes called from the code extract; and
references to, or entity identifiers for, artifacts storing comments extracted from the code extract.

8. The method of claim 4 wherein the entity metadata contained in an entity descriptor corresponding to a transformation includes one or more of:
references to, or entity identifiers for, entity descriptors representing input and output data sets; and
indications of one or more logical operations that together comprise the transformation.

9. The method of claim 4 wherein the entity metadata contained in an entity descriptor corresponding to an artifact includes one or more of:
an indication of the type of artifact;
references to, or entity identifiers for, data sets or models described by the artifact;
references to, or entity identifiers for, the code that generated the artifact; and
output content, including comments, graphs, statistics, testing and validation results, data-scientist notes and observations.

10. The method of claim 3 wherein an entity descriptor further comprises an entity-specific header that includes one or more of:
a name;
a subtype indication; and
a file name, URL, or other reference to a stored-data implementation of the entity.

11. The method of claim 3
wherein a history of the computational-model-generation process and states of the computational-model-generation process are represented as a graph that includes nodes connected by directed edges, each node representing one of a data set, a computational model, a code extract, a transformation, or an artifact and each edge representing a relationship between the entities represented by nodes connected by the edge; and
wherein the graph is constructed by the backend process from the information contained in entity descriptors stored in the centralized database.

12. The method of claim 11 wherein the graph represents a lineage and pathways from input data sets to models and other products of the computational-model-generation process and thus represents the history of the computational-model-generation process, with a state of the computational-model-generation process at a particular point in time represented by a portion of the graph that includes nodes with timestamps equal to or less than the particular point in time.

13. The method of claim 3
wherein the method collects and stores documentation and intermediate results during multiple, concurrent computational-model-generation processes and subsequently provides a history of the steps carried out, computational entities consumed, and intermediate results produced during the multiple, concurrent computational-model-generation processes and reconstructs specified states of one or more of the computational-model-generation processes at specified time points;
wherein one or more listener processes are incorporated within, or associated with, multiple development-environment applications that control multiple development environments in multiple computer systems of a first set of computer systems to respond to multiple data-collection events and multiple autolog events; and
wherein one or more backend processes are incorporated into one or more of a second set of computer systems to receive and process multiple autolog information packages and receive and process multiple requests for histories and states of the multiple computational-model-generation processes.

14. A computer-readable data-storage device or container that stores computer instructions that, when executed by processors within computer systems, control the computer systems to carry out a method that captures and stores documentation and intermediate results during a computational-model-generation process and that subsequently provides a history of the steps carried out, computational entities consumed, and intermediate results produced during the computational-model-generation process and reconstructs a specified state of the computational-model-generation process at a specified time point by:
incorporating a listener process within, or associating the listener process with, a development-environment application that control a development environment, incorporated in a first computer system, that implements all or a portion of the computational-model-generation process;
responding, by the listener process, to a data-collection event during the computational-model-generation process, by collecting and storing information related to the steps carried out, computational entities consumed, and intermediate results produced during a portion of the computational-model-generation process;
responding, by the listener process, to an autolog event during the computational-model-generation process, by retrieving stored information related to the steps carried out, computational entities consumed, and intermediate results produced during a portion of the computational-model-generation process, packaging the retrieved stored information into an autolog information package, and forwarding the autolog information package to a backend process incorporated in a second computer system;
receiving, by the backend process, the autolog information package, analyzing the information contained in the autolog information package in order to update information, stored in a centralized database, that represents the steps carried out, computational entities consumed, and intermediate results produced during the computational-model-generation process; and
receiving, by the backend process, a request for a history and/or state of the computational-model-generation process for a requesting entity, reconstructing the history of the computational-model-generation process using information stored in the centralized database and/or determining a state of the computational-model-generation process at a specified point in time, and returning the history and/or determined state to the requesting entity.

15. A system that collects and stores documentation and intermediate results during multiple computational-model-generation processes and that subsequently provides histories of the steps carried out, computational entities consumed, and intermediate results produced during the multiple computational-model-generation processes and that reconstructs states of the computational-model-generation processes at specified time points, the system comprising:
one or more listener processes incorporated within, or associated with, each of multiple development-environment applications that control multiple development environments, incorporated in a first set of computer systems, that implement all or a portion of the multiple computational-model-generation processes, each of the one or more listener processes
responding to data-collection events, during the multiple computational-model-generation processes, by collecting and storing information related to the steps carried out, computational entities consumed, and intermediate results produced during portions of the computational-model-generation processes, and
responding to autolog events, during the multiple computational-model-generation processes, by retrieving stored information related to the steps carried out, computational entities consumed, and intermediate results produced during portions of the computational-model-generation processes, packaging the retrieved stored information into autolog information packages, and forwarding the autolog information packages to one or more backend processes incorporated in one or more of a second set of computer systems; and
the one or more backend processes, incorporated in one or more of the second set of computer systems, that
receive the autolog information packages, analyze the information contained in the autolog information packages in order to update information, stored in a centralized database, that represents the steps carried out, computational entities consumed, and intermediate results produced during the multiple computational-model-generation processes, and
receive requests for histories and/or states of the multiple computational-model-generation processes from one or more requesting entities, reconstructing histories of the multiple computational-model-generation processes using information stored in the centralized database and/or determining states of the computational-model-generation processes at specified points in time, and returning the histories and/or determined states to the requesting entities.

16. The system of claim 15 wherein the steps carried out, computational entities consumed, and intermediate results produced during the computational-model-generation process include:
one or more data sets;
one or more computational models;
one or more code extracts, such as portions of routines, routines, and programs;
one or more transformations carried out on data sets to produce transformation-generated data sets; and
one or more artifacts, output data generated during the computational-model-generation process that include graphs, statistics, metrics, documentation, comments extracted from code, testing and validation results, and analyses.

17. The system of claim 16 wherein information collected and stored by a listener process for a data set, computational model, code extract, transformation, or artifact and subsequently stored in the centralized database by the backend process is incorporated into an entity descriptor, wherein an entity descriptor is a data structure stored in the memory of a computer system and/or in a data-storage device or appliance that includes:
a header, containing
an entity identifier,
an indication of the type of entity represented by the entity descriptor,
a timestamp,
a version indication, and
a checksum; and
entity metadata, which includes entity-specific information corresponding to the data set, computational model, code extract, transformation, or artifact represented by the entity descriptor.

18. The system of claim 17
wherein the entity metadata contained in an entity descriptor corresponding to a data set includes one or more of
the data set,
information that identifies a database, file, or other computational entity from which the data set can be extracted, and
references to, or entity identifiers for, artifacts generated from the data set;
wherein the entity metadata contained in an entity descriptor corresponding to a computational model includes one or more of
an indication of, or reference to, a computational method or computational model,
the values of various model parameters,
a number of node levels,
a number of nodes in each level of the computational model,
an activation function,
input and output vector specifications for neural-network and large-language models,
references to, or entity identifiers for, training datasets, and
references to, or entity identifiers for, artifacts storing metrics and statistics generated during evaluation of the computational model;
wherein the entity metadata contained in an entity descriptor corresponding to a code extract includes one or more of
the code extract,
references to, or entity identifiers for, the code extract,
references to, or entity identifiers for, inputs to the code,
references to external code libraries, routines, and processes called from the code extract, and
references to, or entity identifiers for, artifacts storing comments extracted from the code extract;
wherein the entity metadata contained in an entity descriptor corresponding to a transformation includes one or more of
references to, or entity identifiers for, entity descriptors representing input and output data sets, and
indications of one or more logical operations that together comprise the transformation; and
wherein the entity metadata contained in an entity descriptor corresponding to an artifact includes one or more of
an indication of the type of artifact,
references to, or entity identifiers for, data sets or models described by the artifact,
references to, or entity identifiers for, the code that generated the artifact, and
output content, including comments, graphs, statistics, testing and validation results, data-scientist notes and observations.

19. The system of claim 17
wherein a history of the computational-model-generation process and states of the computational-model-generation process are represented as a graph that includes nodes connected by directed edges, each node representing one of a data set, a computational model, a code extract, a transformation, or an artifact and each edge representing a relationship between the entities represented by nodes connected by the edge; and
wherein the graph is constructed by the backend process from the information contained in entity descriptors stored in the centralized database.

20. The system of claim 19 wherein the graph represents a lineage and pathways from input data sets to models and other products of the computational-model-generation process, and thus represents the history of the computational-model-generation process, with a state of the computational-model-generation process at a particular point in time represented by a portion of the graph that includes nodes with timestamps equal to or less than the particular point in time.
